(19) United States
(12) Patent Application Publication
(10) Pub. No.: US 2019/0209984 A1
(43) Pub. Date: Jul. 11, 2019

(54) Method and Apparatus for Creating Color Solution Mixture

(71) Applicant: Thrivo Technologies, Inc., Moorestown, NJ (US)

(72) Inventors: Jon Austin Lubow, Moorestown, NJ (US); Louis John Lubow, Moorestown, NJ (US); Caio Cesar RODRIGUES MUCCHIANI, Philadelphia, PA (US)

(21) Appl. No.: 16/242,408

(22) Filed: Jan. 8, 2019

Related U.S. Application Data
(63) Continuation of application No. PCT/US2017/041037, filed on Jul. 7, 2017.
(60) Provisional application No. 62/359,935, filed on Jul. 8, 2016.

(51) Int. Cl. B01F 13/10; B01F 7/18; A45D 44/00; B67D 7/14

(52) U.S. Cl. CPC B01F 13/1063; B01F 7/18; B01F 7/00583; B67D 7/14; A45D 44/005

(57) ABSTRACT

A method of creating color solution, comprises the steps of: receiving color shade solution values corresponding to respective color shade solutions and color shade quantity values corresponding to respective amounts of said respective color shade solutions; mapping each of said received color shade solution values to respective locations where said respective color shade solutions are stored; and releasing into a mixing container said respective color shade solutions in said respective amounts. An apparatus is capable of performing the above steps.

### CROSS-REFERENCE TO RELATED APPLICATIONS

The present application is a continuation of PCT Application No. PCT/US2017/041037 filed on Jul. 7, 2017, which claims priority from U.S. Provisional Application No. 62/359,935, filed on Jul. 8, 2016, the contents of which are both incorporated herein by reference.

### FIELD OF THE INVENTION

The present invention relates to color solution and more specifically to color solution mixtures. In particular, a method and apparatus are disclosed for enabling mixture of color solutions for use in coloring hair.

### BACKGROUND OF THE INVENTION

Hair care is a booming industry, with international sales that generate billions of dollars in sales. One very popular form of hair care is hair coloring, namely a process of changing the color of a person's hair. Hair coloring is done for a multitude of cosmetic reasons, including covering greying hair, changing hair color, or modifying hair color after chemical damage. Some estimates place the number of American women that color their hair at 75 percent.

Hair coloring can be done at home, typically with solutions that are purchased through retail outlets. Many consumers, however, prefer to have hair coloring done professionally, in a salon, and by a licensed individual that not only has experience but access to professional equipment and supplies. Salons thus stock an assortment of hair coloring dyes, in numerous colors, shades and strengths. A hair stylist will typically mix dyes of various colors or shades in order to obtain a hair dye solution mixture that will produce a desired hair color shade. Depending upon the type of chemicals being used, a developer or oxidizing agent may be added to the hair dye mixture before the mixture is applied to a person's hair (in order to activate the color properties).

Hair coloring typically falls into one of the following categories: permanent, demi-permanent, semi-permanent and temporary color. Permanent hair color usually includes ammonia and is mixed with developer or oxidizing agent. Demi-permanent hair color includes an agent other than ammonia and is also used with developer, although the developer may be different than the developer used with Permanent hair color. Semipermanent hair color include little to no developer, peroxide or ammonia. Temporary hair color does not penetrate hair's cuticle layer, and thus can be removed with a single washing.

After entering a salon (and determining the desired color and formula for that person's unique hair type), a hair stylist will mix various hair dye solutions in a bowl, add developer or oxidizing agent if necessary, mix the contents of the bowl, and apply the hair dye solution mixture to a customer's hair. After an appropriate processing time (typically 30-45 minutes) the hair dye solution mixture is washed off of the person's hair, and the hair will subsequently dry (either with or without hot air being blown onto the dyed hair).

### SUMMARY OF THE INVENTION

A method of creating color solution, comprises the steps of: receiving color shade solution values corresponding to respective color shade solutions and color shade quantity values corresponding to respective amounts of said respective color shade solutions; mapping each of said received color shade solution values to respective locations where said respective color shade solutions are stored; and releasing into a mixing container said respective color shade solutions in said respective amounts. An apparatus is capable of performing the above steps.

### BRIEF DESCRIPTION OF THE DRAWINGS

FIG. 1 illustrates a graphic user interface for entering data into a computing device in accordance with an exemplary embodiment of the present invention.

FIG. 2 illustrates a main menu of a graphic user interface in accordance with an exemplary embodiment of the present invention.

FIG. 3 illustrates an exemplary page of a graphic user interface used for mixing hair dye solution in accordance with an exemplary embodiment of the present invention.

FIG. 4 illustrates a further exemplary page of a graphic user interface used for mixing hair dye solution in accordance with an exemplary embodiment of the present invention.

FIG. 5 illustrates a further exemplary page of a graphic user interface which is useful for explaining operation of at least one exemplary embodiment of the present invention.

FIG. 6 illustrates an exemplary page of a graphic user interface which illustrates how formulas are assigned to clients in accordance with an exemplary embodiment of the present invention.

FIG. 7 illustrates an exemplary page of a graphic user interface which illustrates how data is stored for customers in accordance with an exemplary embodiment of the present invention.

FIG. 8 illustrates an exemplary page of a graphic user interface that is useful for understanding how some details may be stored for a customer in accordance with an exemplary embodiment of the present invention.

FIG. 9 is an exemplary page of a graphic user interface which illustrates some data which may be obtained and/or displayed with regard to at least one exemplary embodiment of the present invention,

FIG. 10 illustrates an exemplary canister for storing hair dye solution in accordance with an exemplary embodiment of the present invention.

FIG. 11 is a further view of a canister for storing hair dye solution in accordance with an exemplary embodiment of the present invention.

FIG. 12 is yet another view of a canister for storing hereby solution in accordance with an exemplary embodiment of the present invention.

FIG. 13 illustrates a mounting bracket which may be used for mounting the canister which is illustrated in FIGS. 10, 11, and 12 in accordance with an exemplary embodiment of the present invention,

FIG. 14 is a perspective view which illustrates exemplary canisters which are used for dispensing and combining hair dye solution in accordance with an exemplary embodiment of the present invention.

FIG. 15 is a further view of the storage system that is illustrated in FIG. 14.

FIG. 16 is a perspective view of a bowl, along with apparatus for moving the bowl, in the vicinity of various canisters in accordance with an exemplary embodiment of the present invention.

FIG. 17 is a further perspective view of a bowl and further apparatus for moving the bowl in the vicinity of various canisters in accordance with an exemplary embodiment of the present invention.

FIG. 18 is a further perspective view of the bowl that is illustrated in FIGS. 16 and 17.

FIG. 19 is a perspective view of an actuator which may be used for enabling hair dye to be dispensed from canisters in accordance with an exemplary embodiment of the present invention.

FIG. 20 is a side view of an alternative embodiment from the embodiment illustrated in FIG. 17 for dispensing hair dye.

FIG. 21 is a block diagram of exemplary electronics for controlling dispensing of hair dye in accordance with an exemplary embodiment of the present invention.

FIG. 22 is exemplary table which stores data which may be used for dispensing hereby solution in accordance with an exemplary embodiment of the present invention,

FIG. 23 is a flowchart diagram which illustrates operation of indicating hair dye and amount thereof in accordance with an exemplary embodiment of the present invention.

FIG. 24 is a flowchart diagram which illustrates dispensing of hair dye in accordance with an exemplary embodiment of the present invention

FIG. 25 is a flowchart diagram which illustrates validation of canisters and indicating location of hair dyes in accordance with an exemplary embodiment of the present invention.

FIG. 26 is a block diagram that illustrates various hardware components and communication therebetween.

FIG. 27 is a flow chart diagram that illustrates exemplary steps for providing sufficient amounts of color solution in accordance with an exemplary embodiment of the present invention.

FIGS. 28A and 28B is a further flow chart diagram that illustrates further exemplary steps for providing sufficient amounts of color solution in accordance with a further exemplary embodiment of the present invention.

### DETAILED DESCRIPTION

As previously explained, a hair stylist adds various hair color dyes into a bowl, adds developer or oxidizer if needed, and then mixes the contents of the bowl. The mixed contents of the bowl are then applied to a person's hair. While this process produces professional level results, there are problems with this method and there are ways for the method to be improved:

1) When a hair stylist is mixing hair color solution, he/she selects various containers (e.g. tubes) of various hair color solutions, and enters the solutions into a bowl. While a hair stylist tries to be precise with regard to the quantity of solution being dispensed from each container, the hair stylist is dispensing the solution manually. Therefore, it may be difficult to dispense a precise quantity of hair color. As a result, the final hair color mixture may be “off” and not produce the expected hair color change.

2) As hair grows, undyed hair roots are exposed. Thus, after a period of time, many people will return to a salon to have their hair dyed again. As previously explained, the various solutions are dispensed manually by a hair stylist. If the solutions are not dispensed in the identical amounts that they were dispensed the last time a customer had their hair dyed, the resulting color will be different than the previous color. As many people desire their hair to have a consistent, natural, color, a change in color after each visit to the hair salon can be extremely undesirable.

3) Hair stylists dispense hair dye solutions into a mixing bowl and may not consider how much solution is desirable in order to properly dye a person's hair. Excess solution in a mixing bowl (i.e. that is not used to dye a person's hair) must be discarded. This results in waste and unnecessary expense.

4) A salon is required to stock a large variety of hair color dyes in order to color a customer's hair in any shade that they wish. If a particular hair dye shade is not available (because, for example, it has been completely used, and either not reordered or the reorder has not yet arrived at the salon), then certain hair shades cannot be created at that salon (or can created, but with difficulty).

5) Because hair dye solutions are dispensed manually by a hair stylist, it is difficult to know exactly how much hair dye solution is used each day, each week, each month, etc. This makes it difficult to track product usage, identify hair stylists that are creating waste, and to reorder depleted stock in a timely manner.

6) There is a plethora of hair dye solutions—they are available in a wide variety of shades—and each shade is stored in a respectively different container. Thus, it may be time consuming and challenging to find a specific container (e.g. tube) of color solution that a hair stylist desires to use.

7) There is an unknown nature regarding how much hair color solution may be used by a salon in future weeks, months, etc. So if a salon routinely orders a restock of hair color solution for next week at the end of this week, there are no solid metrics to base how much should be ordered. A salon may place an order for restock (or a reorder) based on what is presumed to be “enough”. This practice may cause over or under ordering.

A method and apparatus are thus described for providing hair dye solutions.

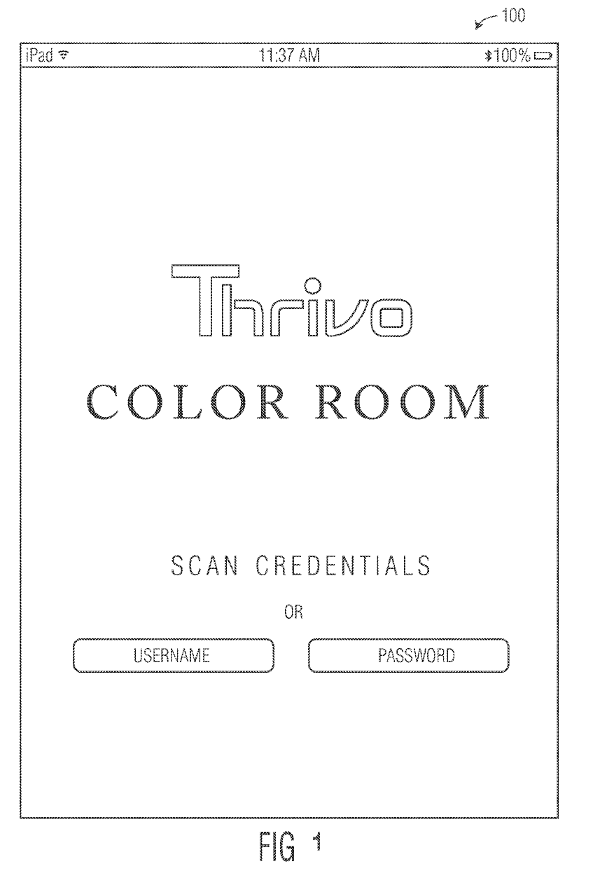

In one exemplary embodiment of the present invention, hair dye solutions are mixed after information is entered into a computing device. An exemplary graphic user interface (GUI) for entering data into a computing device is illustrated in FIG. 1. The illustrated GUI allows a hair stylist, for example, to be able to obtain a hair dye mixture in an automated manner. The GUI illustrated in FIG. 1 and the other figures included herein is merely exemplary, as it is understood that there may be many other formats and methods for enabling the input and/or access of data as exemplified below.

The user interface is the link between the human element and the functionality of the machine. It is intended for use on a touch screen device such as an iPad for intuitive control. The interface may preserve the human artistry of hair color allowing the stylist to input their formulas with ease and familiarity.

Each user is enrolled by the salon administrator account which will ensure that each salon maintains control of who has access to the apparatus that dispenses and possibly mixes a plurality of hair dye solutions. During the enrollment process, the administrator will determine what level of access that user will be granted, from whether that user has the ability to view salon-wide usage and financial reports, to the authority to unlock the front access door of the machine that dispenses hair dye solutions to remove and insert color canisters from the interface. These are merely examples of the various types of access that can be granted to each user. Other levels of access may be available as well. One exemplary aspect of the system is its ability to monitor the usage, predict when more of a specific color will be needed, as well as automatically ordering hair color and developers. The orders would be initiated by the system and would be sent to a distributor in order for the hair color dye order to be processed and shipped. This aspect of the invention could optionally be working in tandem with scheduling software to recognize returning clients and new clients to be able to better predict usage (for color and developer). Since all the clients may have profiles in the system, it is known how much and what shade these clients have historically needed (or desired). Using this data, it is possible to predict with more certainty and accuracy each order cycle for reordering hair color solution and/or developer (machine learning). Also, payment processing for the color order could be done through the software that is performing the reordering.

Every interaction with the exemplary graphic user interface may begin with a login screen. A successful login will be the result of one of the following entry methods; Username and password, a scan of biometric credentials (such as fingerprint scan, facial recognition, etc.), or the use of a readable identification card through the use of a bar code or chip.

The purpose of an access control step such as this will be two fold, each being vital to the overall functionality of creating a cohesive unit between human and machine. Firstly, it would act to ensure a high level of security in order to prevent unauthorized access both to the interface as well as the machine. Secondly, the act of logging in would enable the system to recognize the current user allowing for a plurality of features including the ability to track all aspects of an individual's utilization of the machine including color usage, as well as the ability to automatically populate a user s saved preferences, data, and authorizations.

Following a successful login, a stylist would be presented with four options on the main menu/hub page. The four options are currently named Mixing Bowl, Client Book, Reports, and Settings. Each selection would direct the user to a different page. The design is minimalistic and simplistic to allow the interface to almost fade into the background and allow the stylist to intuitively know how to interact with it in order to accomplish their task seamlessly. This is the central hub of the interface; every subsequent page has the option to return directly to this menu/hub page by tapping on the either the logo or the Color Room wording.

The “Mixing Bowl” menu option 201 directs the users to the mixing page. This is the most unique, creative, and propriety page within the interface. It attempts, successfully, to take the heuristics of the current manual technique of hair color formulation, and replicates it for a digital interface. By mimicking the manual mixing technique that stylists are both familiar with as well as have been trained on it will facilitate an easily surmountable learning curve. The intuitive nature of this page stems from the illustration of a graduated cylinder which acts as both a way to select the desired amount while also simultaneously displaying all of the already mixed colors in easy to understand format.

1) The stylist would choose an amount of hair color or developer by either dragging their finger up to the desired amount on the cylinder, and, if desired, tapping the cylinder which would allow for a numerical quantity to be entered via a keypad that would appear.

2) The stylist would select what hair color that they wanted on the left side where it is categorized by hair color level. Every hair color brand uses various color levels to name and distinguish the dozens upon dozens of different colors they have in a single code, such as 6NN. Hair levels range from 1 to 11+, these values indicate how dark or light a color is or will be. Level one is the darkest black to level eleven (or higher) which is the lightest blonde. Under each level there are many hair colors that have varying underlying shades.

These two steps can also be done in reverse by selecting the hair color first, then selecting an amount of hair dye solution with the selected hair color. In one exemplary embodiment of the present invention, there is no proper first and second step, it can go in any order.

Developer is added to every hair color formula (depending upon the type of hair color being mixed) as it activates the chemicals in the hair color to allow it penetrate the hair shaft. There is a variety of different developers; there is usually 10 volume, 20 volume, 30 volume, and 40 volume; however other volumes may be available as wells. It is almost entirely combined in a 1:1 ratio with the total hair color mixed. In one embodiment, the stylist is given the option of simply selecting a 1:1 ratio as the amount of whatever developer they select. In another embodiment, the stylist is given another ratio, or is given the option to select another ratio. In another embodiment, the hair stylist is given the option to select a specific amount of developer. As the different hair colors are combined and the developer is added it will display in the virtual cylinder. When the stylist is finished mixing she he would tap the “dispense” button which would initiate the machine to begin dispensing the actual hair color formula for use. If the formula is not already assigned to a saved client then as soon as the “dispense” button is pressed the user will be prompted to choose from three options to; 1) save the formula as a new client, 2) save the formula under an existing client, or 3) not save the formula for future use.

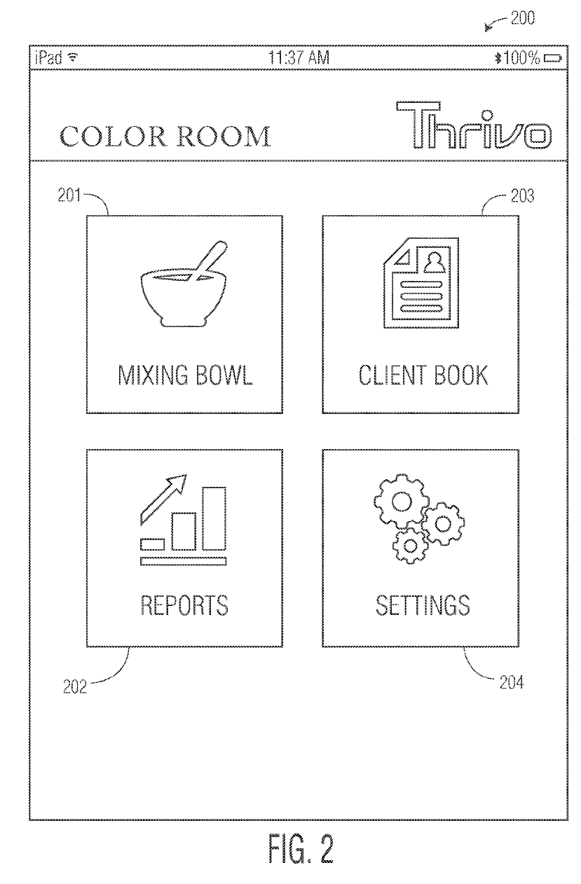

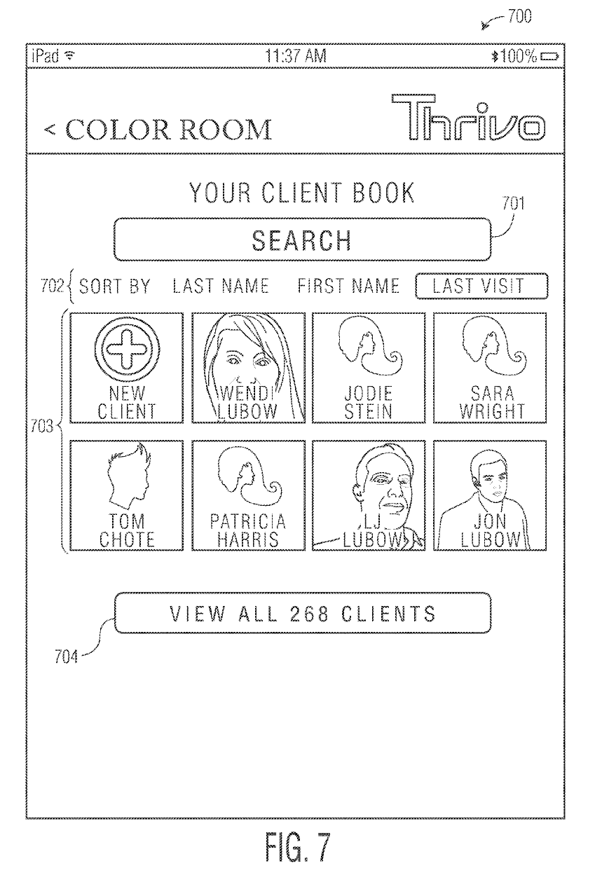

The “Client Book” menu option 203, FIG. 2 (see also FIG. 7), directs users to that individual stylist's saved clients. It is a searchable database. Within each client's profile their current formula is saved, as well as all past formula variations, to ensure 100% accurate, quick and infinitely repeatable hair color formula dispensed from the machine. This would eliminate any and all inconsistencies in a client's hair color results that regularly occur with manual mixing due to human error in combining colors with less than precision accuracy. The stylist also has the ability to modify a previously used and saved client formula. Other exemplary data that would be recorded automatically could be all of the dates that they received hair color services and the correlating formula at each visit. The client's name, phone number, address, any notes as well as photographs of their hair can all be inputted and saved. The saved data in this section is private to that stylist, however, they have the option of sharing either a single client's information or all of their client information with other stylists within their salon.

The information found on all clients in the “client book” menu option 203 may also be used in an algorithm in order to predict the amount of each color as well as developer that is going to be used. Also, it may be able to access the dates each customer is scheduled for hair coloring services in a salon in order to predict the salon cycle of this client and compile it with all other clients. In another exemplary embodiment, this information is coupled with scheduling software to provide information so as to make predictions on future color and developer usage and desirably reorder hair color solution and developer.

The “Reports” menu option 202 would bring the stylist to a page that displays their personal color usage over a defined period of time. The stylist has the option of generating reports based on various exemplary data values, such as (for example) color usage, quantity used, number of clients served, cost accrued through color usage, etc. With authorization from the administrator, a user may generate more detailed reports that also show data on other individual stylists as well as salon-wide reporting. All reporting is in real-time.

The Administrator reporting gives the most highly detailed view of the salon's color inventory, usage, and ordering. From the admin reporting you can narrow down data to a single stylist, a group of stylists, or salon wide. Order reports can be viewed from here as well.

The “settings” menu option 204 is used to change any of the default settings or preferences such as what unit of measure they prefer. This is merely an example and other types of settings may also be modifiable.

Thus, in an exemplary salon, for example, a plurality of hair stylists each have access to a computing system. The computing system may include security features for only allowing authorized stylists access to the computing system. In addition, each stylist using the computing system is desirably required to “logon” so that their respective usage of the computer system can be tracked. As illustrated in FIG. 1, Login Screen 100 is provided at which each stylist is prompted to enter a username and a password before use of the computer system is permitted. Other methods of identifying each stylist are also known. One method is to provide each stylist with some form of ID that is scanned to permit system use. Biometrics and other forms of identification may be used as well. The device that displays Login Screen 100 may include a touch sensitive display screen. Alternatively (or in addition) Login Screen 100 may have data inputted therein using, for example, a mouse and a keyboard.

FIG. 2 illustrates Main Menu Page 200. At this page, the stylist is provided with a variety of options and chooses which option to pursue. In this exemplary embodiment, a plurality of tiles appear on a screen and a further screen is displayed depending upon which of the tiles included in FIG. 2 are touched, clicked, etc. Exemplary options include mixing bowl tile 201, reports tile 202, client book tile 203 and settings tile 204.

Selecting mixing bowl menu option 201 brings the stylist to mixing page 300. Mixing page 300 allows a stylist to obtain a customized hair color solution mixture and will be described in greater detail below.

Selecting reports menu option 202 allows reports to be generated, indicating for example the amounts of each hair color that has been used in a specific time period. Reports tile 202 is described in greater detail below.

Selecting client book menu option 203 allows a stylist to retrieve and/or enter hair dye solution ingredients for the stylists clients. Client book tile 203 is described in greater detail below.

Selecting settings menu option 204 adjusts various settings relating to use of exemplary embodiments of the present invention and will be described in greater detail below.

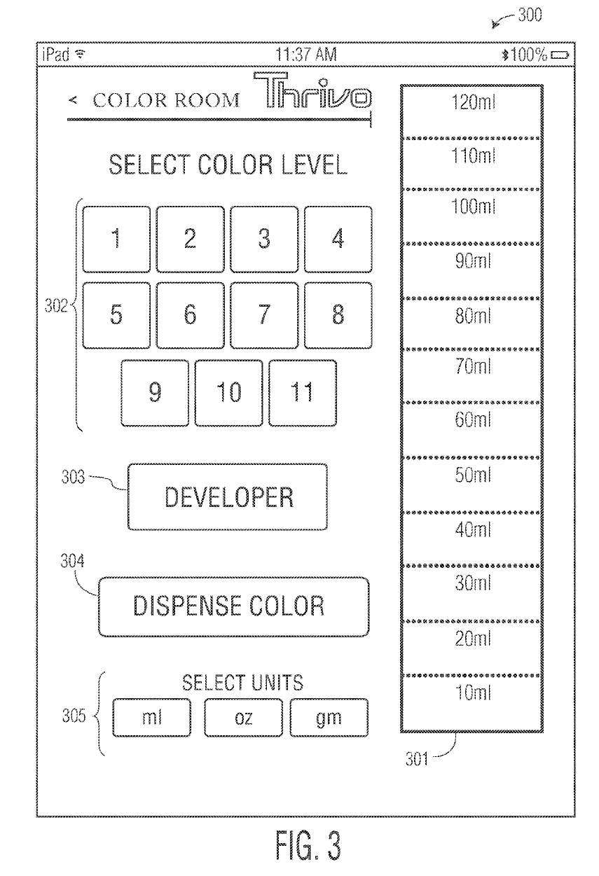

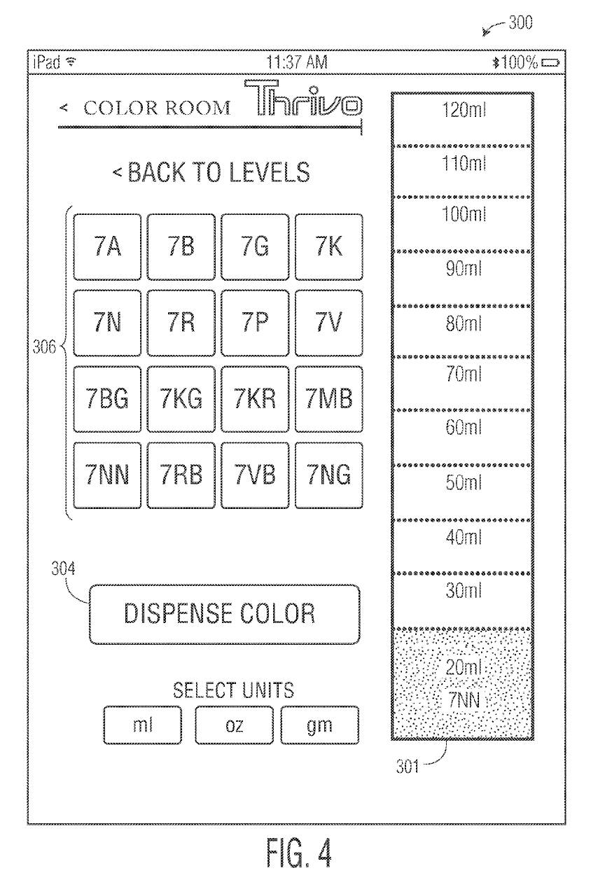

FIG. 3 illustrates mixing page 300 in accordance with an exemplary embodiment of the present invention. As shown in FIG. 3, virtual cylinder 301 is included. Virtual cylinder 301 illustrates the amount of each different hair dye solution that is being mixed together. Level selection 302 is also included. Level selection 302 allows the stylist to select which hair dye solution is to be mixed together. In an exemplary embodiment of the present invention, different hair dye solutions each correspond to one of the level selections included in level selection 302. In a further exemplary embodiment of the present invention, hair dye solutions are selected by going through menus in a tree structure configuration. Thus, for example, tile 1 of level selection 302 corresponds to one group of hair dye solutions and tile 7 of level selection 302 corresponds to another group of hair dye solution. The steps for selecting a specific hair dye solution can be explained by looking at FIG. 3 and FIG. 4. Assume, for example, that a stylist wishes to use a hair dye solution from the group of hair dye solutions that are included at level 7. The stylist would thus select tile 7 from level selection tiles 302 of FIG. 3. This would result in sublevel selection 306 of FIG. 4 becoming visible. The stylist may then select, for example, level 7NN by selecting the level 7NN tile. Next, the stylist selects the amount of hair dye solution (in this example, 7NN) that is to be included in the hair dye solution mixture. In this example, the stylist has selected 20 mL of 7NN by touching the 20 mL mark of virtual cylinder 301.

Each manufacturer uses various designations to indicate the color that is achieved by their hair color solutions. As an example, one popular hair dye solution that is available to professionals is Matrix SoColor. Each (or some) of the tiles 1-11 that appear in level selection 302 may correspond to a respective group of hair dye solutions that are available in the Matrix SoColor line. Additional tiles on separate screens enable a stylist to indicate which hair dye solution is desired after the group of hair dye solutions is designated with level selection tiles 302. Below is a list of exemplary hair dye solutions that that are in the Matrix SoColor line. This list is merely provided as an example. There are multitude of other manufacturers and product lines for hair dye solution that may be used with, or in combination with, the present invention:

1N Black

2N Natural Black

3N Darkest Brown

11P Extra Light Blonde

Thus, in one exemplary embodiment, Level Selection 302 may have more or less than 11 tiles depending on the total number of hair color solutions that are available to the stylist. In another exemplary embodiment, a tile is selected from the choices available in level selection 302, and after that tile is selected, a further tile is selected from sublevel selection 306 in order to choose the actual hair color solution that will be used.

To provide a further example, the stylist selects the tile corresponding to the hair color solution that is desired and then presses an amount on virtual cylinder 301 that corresponds to the amount of selected solution that will be dispensed. If, for example, the stylist desires to prepare a hair dye mixture that comprises 40 ml of 7A Black and 20 ml of 7N Darkest Brown, the stylist would select the following in the following exemplary order:

Tile 7

Tile 7A

40 ml

Tile 7

Tile 7N

20 ml

The exemplary order provided above is merely exemplary. Alternatively, and as an example, volume is selected before each hair dye solution is selected.

After the components of the hair dye mixture have been selected, the stylist can optionally include developer by selecting the Developer tile 303 followed by the amount of developer to be included with the hair dye mixture by selecting the desired amount of developer in virtual cylinder 301. The developer can be added by specifying a particular amount, or specifying a ratio. For example, if the amount of hair dye solutions that are being combined equals 45 mm and a 1:1 ratio of developer is specified, than 45 mm of developer will be added. As previously explained, developer can include peroxide, ammonia, a combination thereof, or some other chemical that causes the hair dye mixture to dye hair.

After the hair dye solutions and developer (if not optional) are selected and stored, dispense color tile 304 is selected and the hair dye mixture is dispensed. The combination of several hair dye solutions that have been dispensed may be referred to as a hair dye solution mixture. Unit selection 305 optionally allows a stylist to indicate the units of measurement with which hair dye solution is selected.

During the process of selecting various hair dye solutions, and amounts, data is stored corresponding to each selection. Each hair dye solution may be represented by a corresponding data value. In the process of selecting hair dye solutions the various data values corresponding to the selected hair dye solutions are stored. This information is retrieved later in order to dispense the desired hair dye solutions and to create the desired hair dye solution mixture.

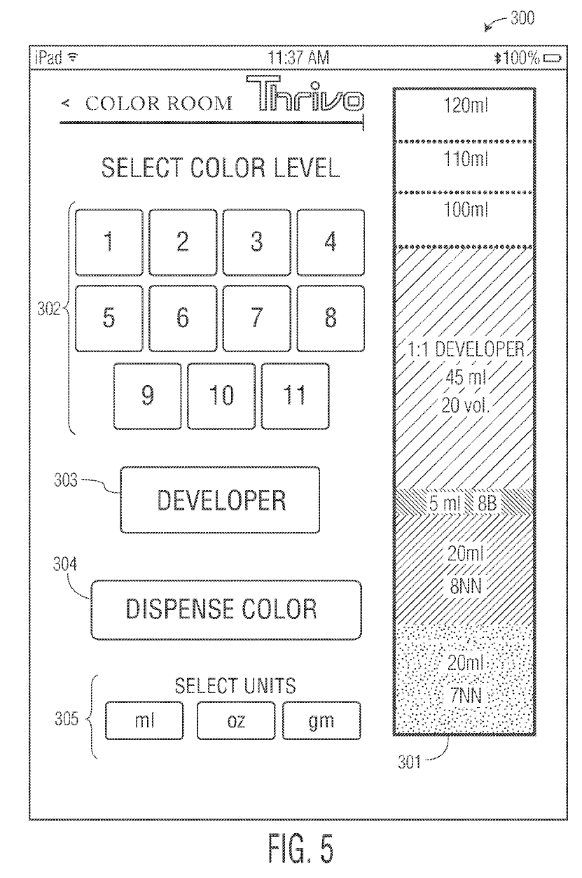

FIG. 5 illustrates mixing page 300 with exemplary hair dye solutions already selected and the hair dye mixture waiting to be dispensed. In the example shown in FIG. 5, the stylist has selected 20 ml of hair dye solution 7NN, 20 ml of hair dye solution 8NN, 5 ml of hair dye solution 8B and 45 ml of developer (for a total of 90 ml of hair color mix that is to be dispensed). Once the dispense color tile 304 is selected, a hair color mixture may be dispensed with ingredients in the aforementioned amounts based upon the value stored relating to hair dye solutions and quantities thereof.

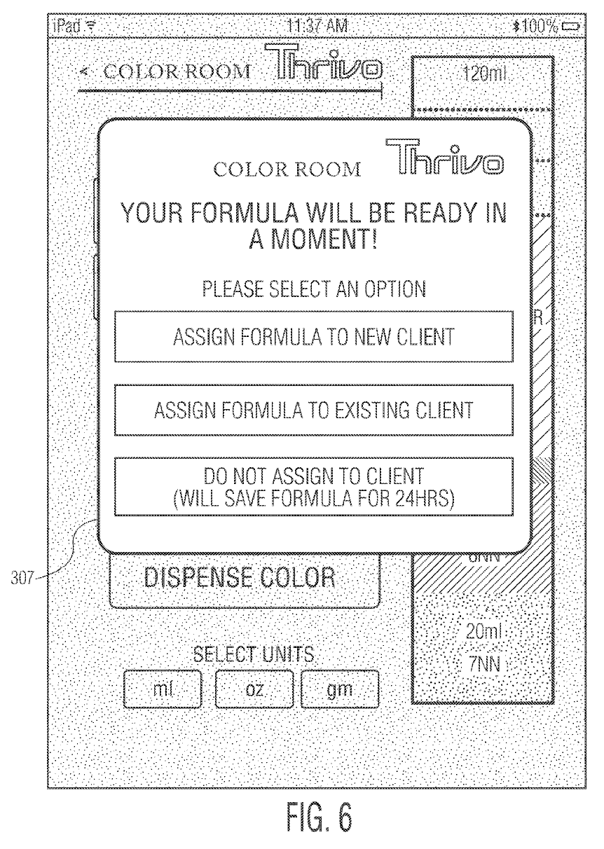

FIG. 6 illustrates post dispense menu 307. After a hair dye mixture has been dispensed, the stylist is then given the option to save for future use a record that indicates the content of a dispensed hair color mixture. Post dispense menu 307 allows the record to be saved a) with the records of an existing client, b) as a record for a new client, or c) not to be saved at all. After the record is saved, it can be retrieved at a later time in order to duplicate the previously created hair color mixture. It may also be possible to modify a retrieved record (i.e. if a change of the customer's hair color is desired).

FIG. 7 illustrates saved clients menu 700 that may be accessed, for example, by selecting client book tile 203 in FIG. 2. Saved clients menu 700 allows information such as the composition of previously dispensed hair color mixture to be stored for new and existing clients. Saved clients menu 700 may, for example, display a tile for each client through some form of identification such as name, photo, etc. Each client may be accessed by a respective tile that is included in client selection 703. A new client tile is also included so that a new client can be added to the saved clients menu 700. Sort options 702 allows clients to be sorted, for example, by first name, last name, etc. Search box 701 allows client names to be searched so that a respective tile that gives access to specific client information can be located. View selector 704 enables tiles for all clients to be displayed.

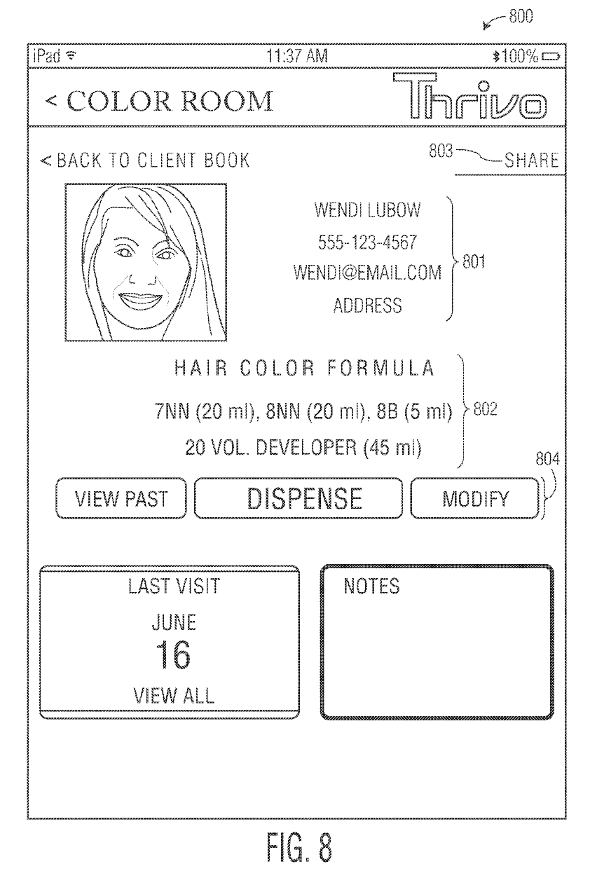

FIG. 8 illustrates a sample client page 800 in accordance with an exemplary embodiment of the present invention. Client data 801 includes information such as a client's contact information. A photo may optionally be included. Hair color formula 802 indicates the composition of a hair color mixture previously dispensed for the selected client. Share feature 803 allows the client information to be shared, for example via email, text messaging, etc. Client information may also be shared internally with other stylists Client action selector 804 allows the stylist to view previous hair color mixtures that have been dispensed for a client, modify stored ingredients of a hair color mixture that has been dispensed to a client, and to dispense a previously stored hair color mixture. Other optional fields may be included such as the date of a previous visit and other notes.

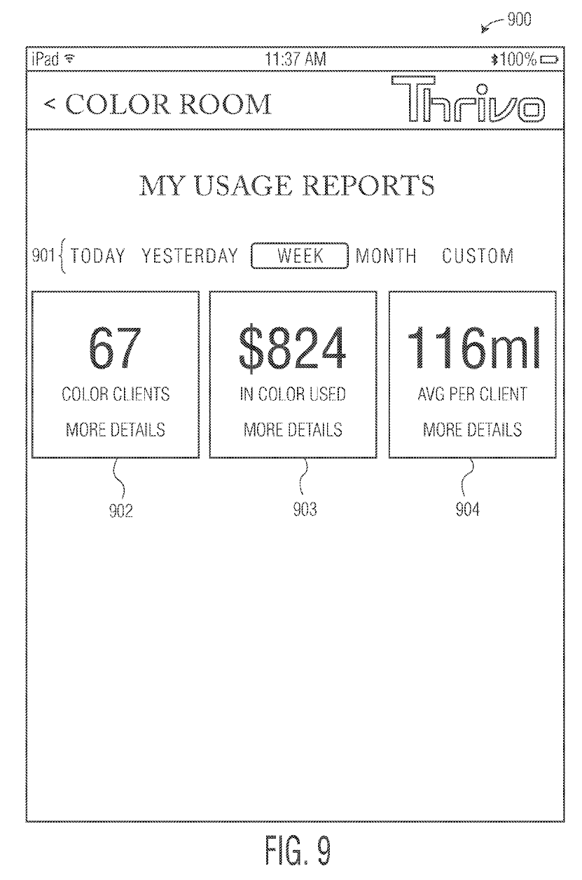

FIG. 9 illustrates exemplary reports page 900. Reports page 900 displays information about previously dispensed hair color solutions. Client number tile 902 displays the total number of clients that have been dispensed hair color mixture, dollar tracker tile 903 indicates the dollar amount of hair dye solution that has been dispensed and quantity tracker 904 indicates the average amount of hair dye mixture that has been dispensed per client. Selecting any tile will provide further details, such as breaking down the data on a customer by customer basis. Range selector 901 allows the information on reports page 900 to be provided for specific time periods, for example: today, yesterday, week, month, custom.

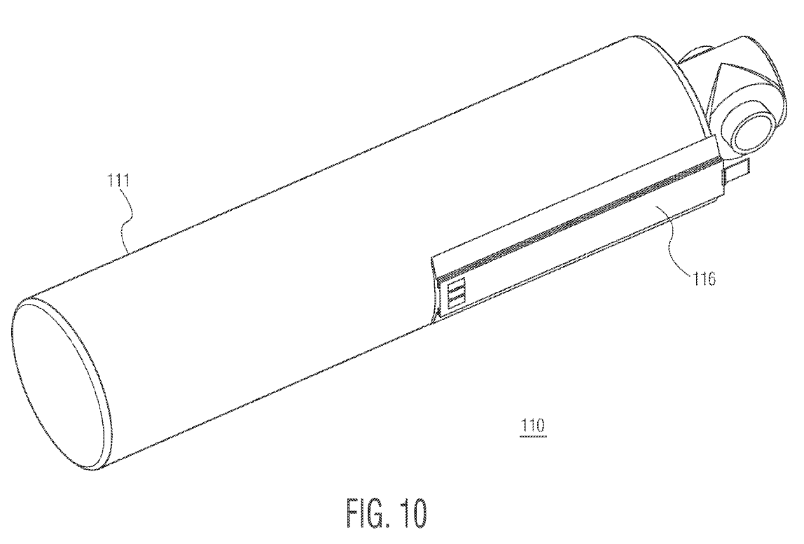

Each hair dye solution is stored in its own respective container. FIG. 10 is a perspective drawing that illustrates a container in accordance with an exemplary embodiment of the present invention. More specifically, canister 110 is shown. Canister 110 may include hair dye solution under pressure so that opening a valve causes hair dye solution to leave canister 110. Alternatively, an input port is provided to which is applied a gas (such as air) under pressure in order to cause hair dye solution to leave canister 100.

The canister function is twofold; one is to act as a storage device for the hair color and allow it to be dispensed evenly and second is to monitor the amount of color in the canister at any time. The storage and dispensing functions will be accomplished through a combination of pressurized air and check valves.

The physical construction of the canister is based around a thin metal shell which could withstand pressurized contents. The inside of the canister will have a thin plastic piston which will be at the bottom of the canister when it is full while allowing a tiny gap of air in the bottom for expanding gas. Running along the entire length of the inside of the canister will be a tube for adding pressurized air to the chamber at the bottom of the canister. The tube will have a valve to allow the intake of pressurized air in the front of the canister and the piston will have a hole in it to accompany the tube. At the front of the canister where the hair color would come out, there is a check valve which lets fluid flow in only one direction and it is angled so the flow would be directed downward into the mixing bowl. The inside of the directing check valve may be coated with a non-stick coating (e.g. Liquiglide) to avoid clogging and oxidation of lingering drops.

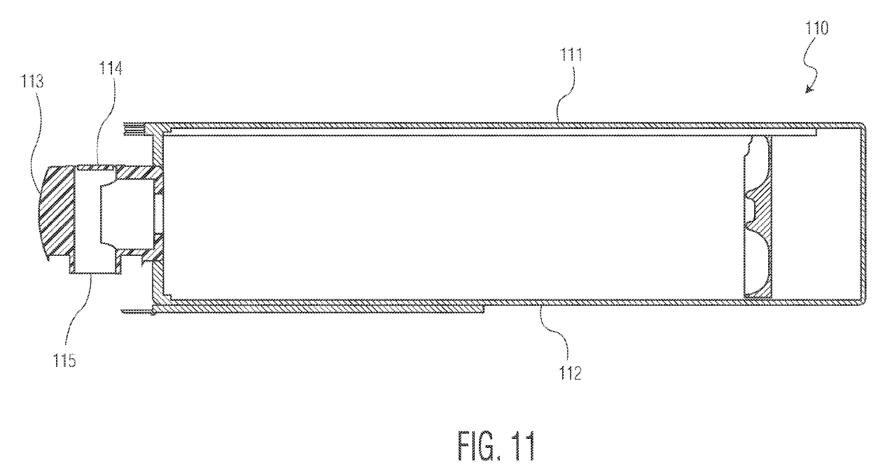

FIG. 11 is a sectional view of a container for storing hair dye solution in accordance with an exemplary embodiment of the present invention. Canister 110 includes body 111 that defines cavity 112 in which hair color solution is stored. Each hair color solution is stored in a respective canister 110. Developer may be stored in a respective canister as well. Each canister includes dispenser 113 through which the hair color solution stored therein is dispensed. Hair color solution is dispensed through dispenser outlet 115.

Hair color solution may be dispensed from canister 110 in a variety of different ways.

To extract the hair color liquid out of the canister, in one exemplary embodiment of the present invention, an assembly utilizes an actuator that includes an electromagnet to force a hose from a small air compressor to connect to a valve located on the top front of a canister forcing the hair color to flow out. This action starts with a solenoid made of thin copper magnet wire wrapped a couple hundred times around a thin iron rod to increase the strength of the magnet. The solenoid and iron will be wrapped in a heat resistant composite. Securely fastened to the solenoid assembly will be the compressor hose. The solenoid will be anchored into a 3D printed ABS base with plastic set screws. The base is designed to have two thin members sticking out of the sides of it which are normal to the axis of the iron core of the solenoid. The two members protruding out of the magnet's base are going to be positioned to stick through two springs. These two springs will be perpendicular to the protruding members and parallel to the magnet. When the magnet is not applying a force from the hose to the canister, these two springs will provide a counter force in the opposite direction of the canister to keep the magnet out of the way but will compress enough and with a low enough spring constant that it doesn't impede the function of the magnet.

In a further exemplary embodiment of the present invention a small air compressor, running continuously and generating compressed air on demand which is less than 15 psi is included. Due to the small value of psi utilized and the very small volume of compressed air needed the compressor will be extremely small and quiet.

Two exemplary embodiments are now presented. In one embodiment, the hair color solution is stored in the canister under pressure (in one example, with a propellant), so that upon opening a valve, the internal pressure in the canister causes the hair color solution to flow out of the canister. For this purpose exemplary dispensing control 114 is illustrated. In another embodiment pressurized gas is coupled to a gas inlet, such as gas inlet 117, and pressurized gas is applied to the hair color solution within canister 110. In this exemplary embodiment, a low pressure valve (not shown) may be included within dispenser 113. The lower pressure valve may be designed so that it is normally in a closed position, but it transitions to an open position upon the application of pressurized fluid (e.g. at or above 0.3 psi), These are merely two examples of how hair color solution is permitted to be dispensed from canister 110. Other methodologies for enabling a solution to leave a canister may be used as well.

To initiate the process of getting the hair color out of the canister and into the bowl, in one exemplary embodiment of the present invention, the actuator would move to the desired canister of color and the electromagnet with the compressor hose would activate to connect the hose to the air intake valve. Pressurized air would flow into the tube which feeds into the air reservoir in the bottom of the canister. When enough pressure is built up against the piston, the check valve will release and allow the color to flow out and direct it into the mixing bowl below. Again, this process is merely exemplary as other methods for enabling hair color dye to be dispensed from canisters may be used.

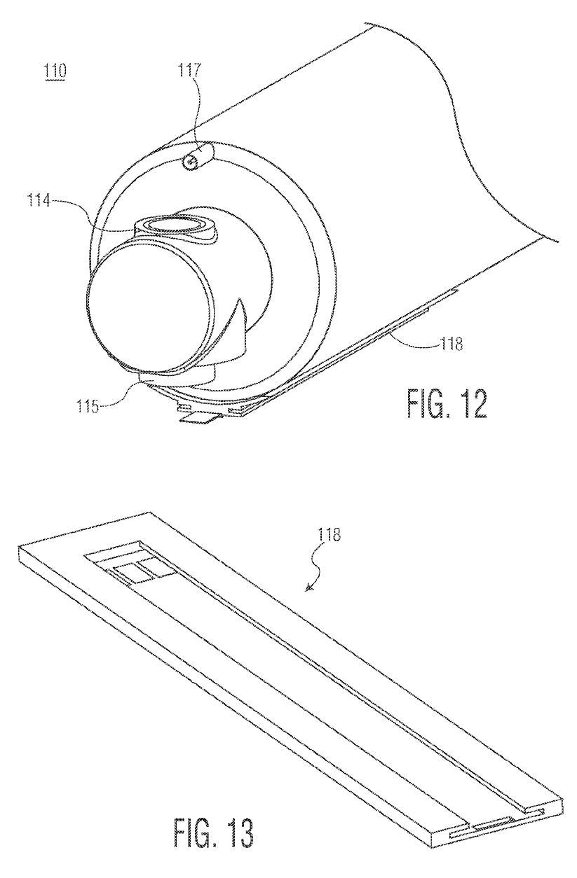

FIG. 12 is another perspective view of canister 110. FIG. 12 again illustrates dispenser outlet 115, exemplary dispenser control 114, and exemplary gas inlet 117.

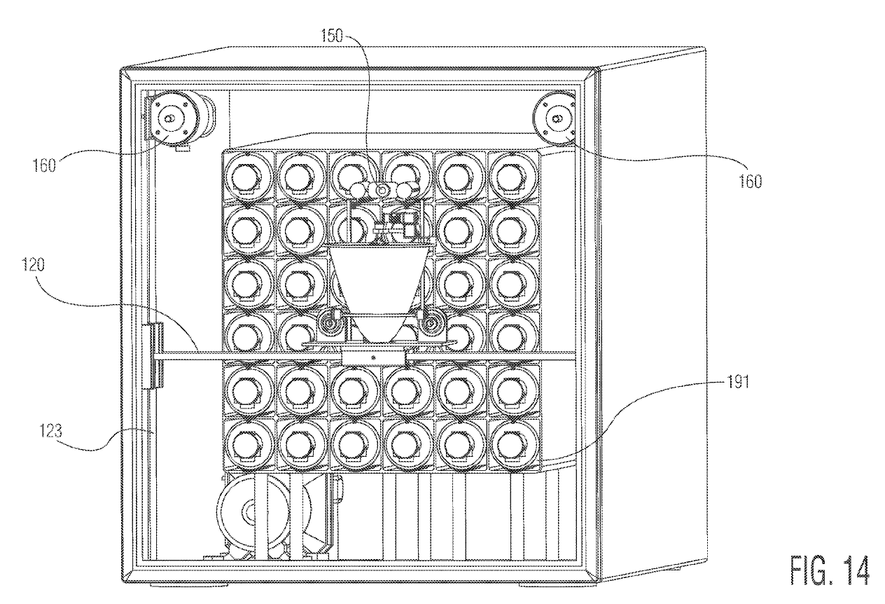

FIG. 13 illustrates a perspective view of mounting bracket 118 upon which canister 110 is mounted. Canister 110 may be attached to mounting bracket 118 using a variety of various techniques, including a track sliding mechanism, a friction hold system, a bolting mechanism whereby bracket 118 is bolted to features located externally on canister 110, etc.

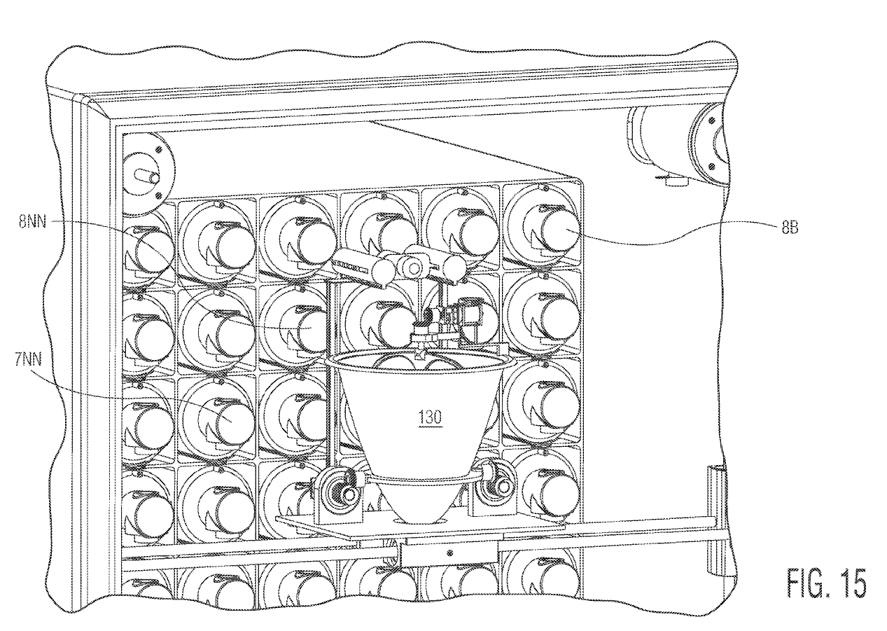

FIGS. 14-18 are perspective drawings of an exemplary apparatus for collecting hair dye solution from various canisters 110.

Generally speaking, each hair dye solution is stored in a respective canister. What s next explained is an exemplary method and/or apparatus for obtaining hair dye solution from certain ones of the canisters in order to obtain a hair dye solution mixture that will dye hair to a desired shade (color).

For the purpose of keeping track of how much color is currently in each canister and allowing certain canisters to be stored in a rack from which the hair dye solutions are dispensed, a smart chip may be embedded into the latching mechanism that locks the canister into the rack. On the mount for each canister inside the rack there will be contacts to read the chip when the locking mechanism is fully engaged and the canister is in place. The mechanism that holds the canister in place may be for example, a plastic set of rails with a female rail on the canister and the male on the rack in the machine. The chip would be on the underside of the canister tucked up above the rails. To insert a canister into the rack, the user would depress a small tab on the front underside of the canister then slide the female rail into the male rail until the canister cannot be inserted any further and the user would then release the tab.

As previously explained, to obtain a hair dye solution mixture that produces a particular shade (color) after being applied to hair (for example), a stylist needs to prepare a mixture of certain hair dye solutions, each in certain amounts. Thus, a method and apparatus are described for dispensing desired hair dye solutions into a common container. After the hair dye solutions (and optionally developer) have been dispensed into the common container, the contents of the container can be mixed before being applied to a person's hair. Note, however, that mixing of the contents of the common container may occur at various times from the moment that the desired hair dye solutions are first indicated until the moment that the hair dye solutions are applied to a person's hair.

In order to prepare the desired hair dye solution mixture, it is desirable for a common container to be near the canisters from which hair dye solution is dispensed. In one exemplary embodiment, the canisters of hair dye solution remain in fixed locations and the common container is brought into the vicinity of those canisters from which hair dye solution is to be dispensed into the common container. In another exemplary embodiment, the common container remains in a fixed location and the canisters of hair dye solution are brought into the vicinity of the common container so that the contents of the desired canisters can be dispensed. In a further exemplary embodiment, both the canisters of hair dye solution and the common container move so that desired canisters are in the vicinity of the common container for dispensing of the desired hair dye solutions. In yet another exemplary embodiment, the canisters of hair dye solution and the common container remain stationary. In this exemplary embodiment, conduits are provided between the canisters of hair dye solution and the common carrier. Hair dye solution is released from selected ones of the canisters so that desired quantities of certain hair dye solutions enter the common container.

FIG. 14 illustrates one such exemplary embodiment described above. In this exemplary embodiment, common container (or mixing bowl) 130 is included. Common container 130 may be a mixing bowl that is moved to the vicinity of various canisters 110 so that desired quantities of certain hair color dyes can be emptied into common container 130. Canisters 110 can be located in a plurality of different configurations: each extending in a horizontal direction next to each other, on top of one another, or some combination thereof, each extending in a vertical direction next to each other (along an x axis), behind one another (along a z axis) or some combination thereof, each extending in a direction somewhere between vertical and horizontal, and in any relationship relative to each other, etc.

In the exemplary embodiment shown in FIG. 14, canisters 110 are arranged in a matrix configuration, both next to each other and above each other in rack 191. Each canister 110 includes a respectively different hair dye solution. Mixing bowl 130 is moved to certain ones of the canisters 110, desired amounts of each canister are dispensed into the mixing bowl, and when all desired hair dye solutions (and optionally developer) have been dispensed into mixing bowl 130, the contents of mixing bowl are mixed and provided to a stylist, or, for example, the contents of mixing bowl are provided to a stylist for mixing (or further mixing). Mixing bowl 130 thus moves along horizontal rails 120 and vertical rails 123 so that it is in the vicinity of those canisters 110 from which hair dye solution is to be dispensed,

When the color is extracted out of the canister it falls into the mixing bowl. The mixing bowl may be, for example, a stainless steel paraboloid shaped bowl coated in a nonstick coating (such as Liquiglide). Optionally attached to the side of the bowl is a member with a small electric motor mounted on it. The motor is to rotate the mixing paddle which is also mounted to the member and allowed to rotate via a ball bearing for smooth motion. To turn the mixing paddle, the motor will have a 90 degree angled gear to allow for the translation of motion between perpendicular axes. On the paddle there will be the accompanying 90 degree gear to mesh with the one on the motor. The paddle's geometry is similar to one you would find on a kitchen mixer, with the main difference being the lack of flat surfaces which have a normal parallel to gravity. This trait is to ensure that in the transfer of liquid from the mixing bowl to the final container there is no chance of any color being caught on the flat surfaces of the mixing paddle. In one exemplary embodiment, the paddle may be made out of stiff silicone rubber to keep the surface of the mixing bowl undamaged. The mixing may occur anytime that there is hair color in the bowl, but not when hair color is flowing into the mixing bowl from a canister 110.

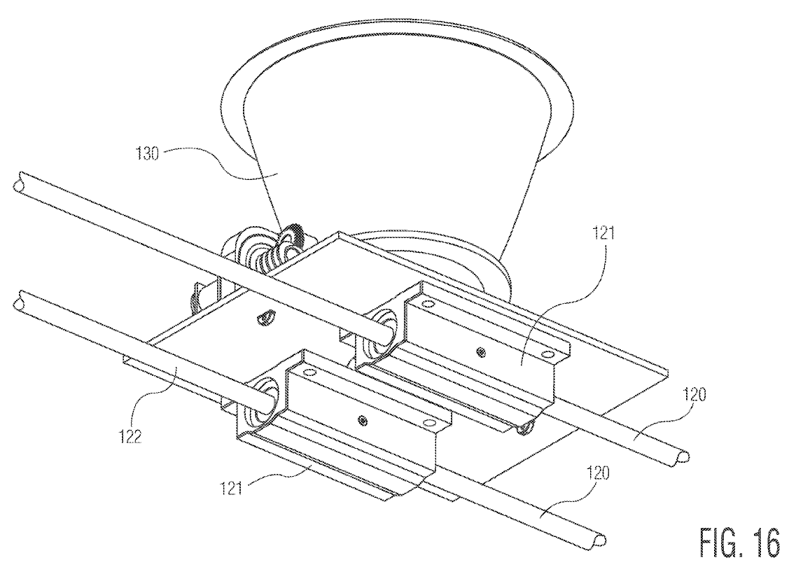

FIG. 15 further illustrates how a stylist may create a hair dye solution mixture in the manner that is illustrated in FIG. 5. Again, the mixture that is formed based on FIG. 5 includes the following components: 20 ml 7NN, 20 ml 8NN, 5 ml 8B, 45 ml developer. In one exemplary embodiment, mixing bowl 130 is moved along horizontal rails 120 and vertical rails 123 so that it is directly under dispenser outlet 115 of canister 110 that contains hair dye solution in shade 7NN. An actuator moves with mixing bowl 130. The actuator interacts with the canister 110 that contains shade 7NN in a manner so that hair dye solution in shade 7NN is dispensed from the canister. The actuation may include any of the methods described above including, for example, actuating a valve so that the contents of canister 110 are dispensed under pressure or supplying gas pressure to the contents of canister 110 so that hair dye solution flows out of canister 110. The actuator interacts with canister 110 containing shade 7NN a sufficient amount of time so that, in this example, 20 ml of shade 7NN departs from canister 110 and enters mixing bowl 130. The actuator then stops interacting with canister 110 so that flow of shade 7NN stops. The mixing bowl 130 then moves to canister 110 that contains shade 8NN. Again, an actuator is actuated so that 20 ml of shade 8NN is dispensed into mixing bowl 130. After 20 ml of shade 8NN has been dispensed into mixing bowl 130, the actuator ceases to actuate, and flow of shade 8NN out of canister 110 stops. Mixing bowl 130 then moves to canister 130 that contains shade 8B. An actuator is actuated so that 5 ml of shade 8B is dispensed into mixing bowl 130. After 5 ml of shade 8B is actuated, the actuator ceases to actuate, and flow of shade 8B out of canister 110 stops. In a further exemplary embodiment, mixing bowl 130 optionally moves to canister 110 that contains developer. An actuator is actuated so that a desired quantity of developer flows into mixing bowl 130, and the actuator then ceases to actuate so that flow of developer out of canister 110 stops.

For the horizontal motion of mixing bowl 130, in one exemplary embodiment of the present invention, a stepper motor is attached to a lead screw. The lead screw has a correspondingly threaded nut which allows for smooth linear motion when the motor is actuated. The lead screw may be anchored on the side without the motor by a ball bearing apparatus to ensure smooth, even rotation. The turning of the lead screw by the motor causes the nut to move linearly corresponding to the direction of the lead screw's threading. The nut is anchored to the cart allowing the cart to move along the rail's axis when the motor is actuated. A very similar setup is used for the vertical motion but instead of having a single lead screw, two lead screws are preferred with one lead screw mounted on each side of the horizontal rails/lead screws. On the end of both of these vertical lead screws are stepper motors to control and actuate the motion. The vertical stepper motors desirably work in sync with each other and actuate at the same time and for the same duration

In a further exemplary embodiment, the mixing apparatus and bowl are mounted onto a cart which transports the bowl everywhere in the plane of the canister nozzles so it has the ability to collect hair color and developer from every canister. The cart is given its mobility through a tracked apparatus in which two rails are running horizontally across the front of the machine and the end of each of these rails is attached to another rail which runs vertically on the front of the machine. In an exemplary embodiment of the present invention, the horizontal motion may be powered by a small electric motor on the end of each set of rails, the motor will turn a spool winding a narrow cable which is anchored to the bottom of the side of the cart that the motor is on. For the cart to move from the left side of the machine to the right, the right side motor would actuate to reel in the cable and therefore the left motor would reel out the cable in an equal amount to what the right motor reeled in. For the vertical motion, a similar system is in place but instead of or in addition to a motor for both sides and for both directions along an axis, gravity may act as the motor to move the horizontal track assembly down. To move the horizontal motion apparatus to the top of the machine from the bottom, both motors mounted on the top of the machine would actuate and reel in the cable to the spool equally on both sides to keep the cart and horizontal rails level as they translate up. Then to move back down, the motors would actuate in the opposite direction and gravity would pull the cart and horizontal rails downward but the motors would unspool the cable at an even pace to control the descent.

To allow the cart to glide smoothly along the rails with very minimal friction, there are linear bearings mounted to the bottom of the cart on each side. The same setup is used for the vertical motion but the end of each horizontal rail is inserted into a milled hole in a linear bearing which is on the vertical rails.

In one exemplary embodiment, the contents of mixing bowl 130 are provided to the stylist (in one example, the stylist simply takes possession of mixing bowl 130, in another example the contents of mixing bowl 130 are poured into another bowl, and the stylist takes possession of that other bowl). The stylist then adds developer (45 ml from a container of developer), mixes everything together, and applies the mixture to a client's hair.

In another exemplary embodiment, mixing bowl 130 is moved to canister 110 of developer shown in FIG. 14, an actuator is actuated so that 45 ml of developer is dispensed into mixing bowl 130, and after 45 ml of developer have been dispensed, actuation stops so that no further developer is dispensed into mixing bowl 130. Then either a stylist can take possession of mixing bowl 130, or the contents of mixing bowl 130 can be poured into another bowl which the stylist takes possession of.

In another exemplary embodiment, the contents of mixing bowl 130 are mechanically mixed before the stylist takes possession of the contents of mixing bowl 130 (either by taking possession of mixing bowl 130 itself or taking possession of another bowl into which the contents of mixing bowl 130 are poured).

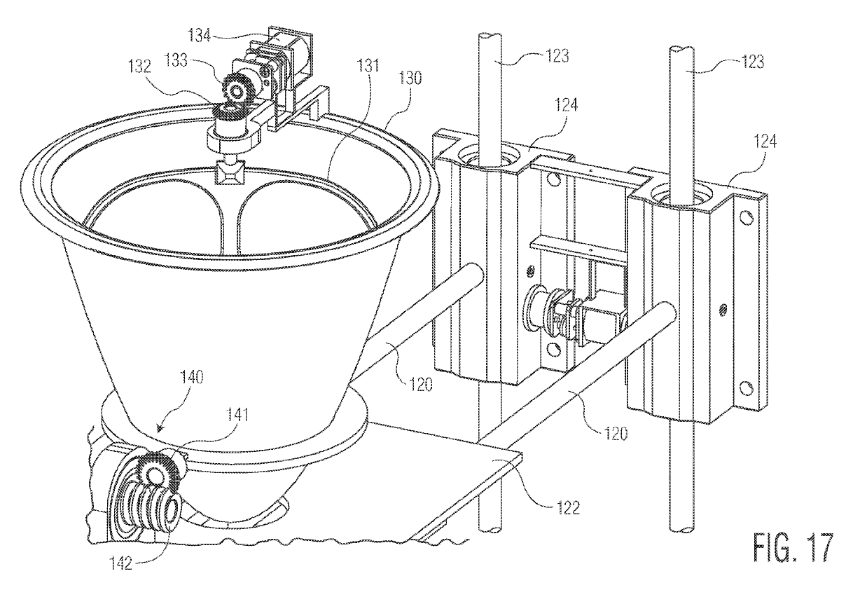

FIG. 16 is a perspective view of the mechanism that moves mixing bowl 130 into proximity with various canisters 110. Mixing bowl 130 appears near the top of the figure. Mixing bowl 130 is supported on top of base 122, Base 122 moves horizontally along horizontal rails 120. Horizontal movement blocks 121 are mounted on the bottom of base 122 and move base 122 along horizontal rails 120. There are several exemplary mechanisms for moving base 122 along rails 120. For example, in one exemplary embodiments, one or both horizontal movement blocks 121 includes a motor, such as a stepper motor (not shown) which when actuated cause movement of base 122 along horizontal rails 120. A stepper motor included in horizontal movement block 121 can be energized for an amount of time that causes horizontal movement of mixing bowl 130. In this manner, horizontal bowl 130 is brought into the vicinity of canister 110 from which hair dye solution is to be dispensed. In another exemplary embodiment, one or more motors is situated on a frame from which horizontal rails 120 are supported. An attachment device, such as a cable, may be connected between horizontal movement block 121 Adam motor which is mounted to the frame that is supporting horizontal rails 120. Again, such a motor can be actuated a sufficient amount of time to cause mixing bowl 130 to be moved into the vicinity of a canister 110 from which hair dye is to be dispensed.

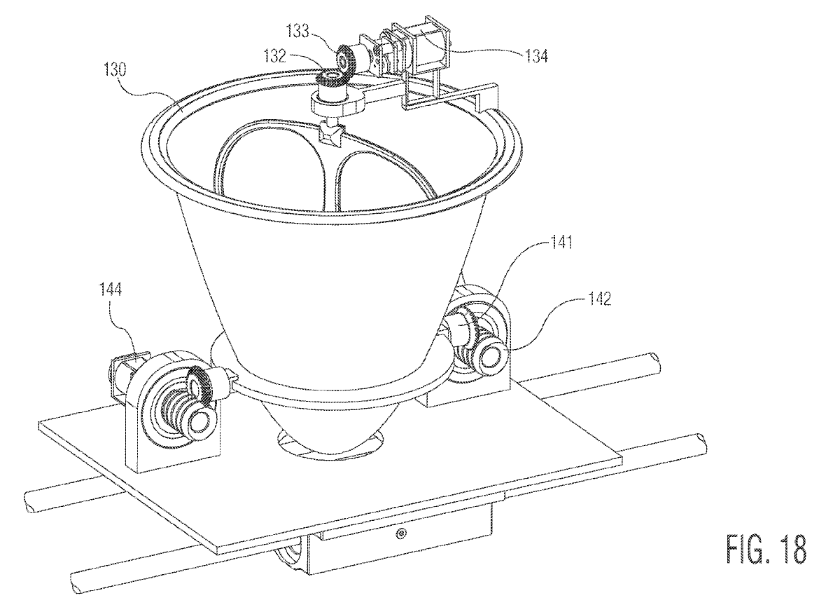

FIG. 17 is a further perspective view of mixing bowl 130. In particular, a mechanism for moving mixing bowl 130 is illustrated. In the view which appears in FIG. 17, horizontal rails 120 are again shown. Furthermore, in FIG. 17, vertical rails 123 are shown. Vertical rails 123 are useful for enabling mixing bowl 130 to be moved vertically relative to various canisters 110. In this manner, it is possible to move mixing bowl 130 vertically to the vicinity from which hair dye solution is to be dispensed. In one exemplary embodiment of the present invention, one or more vertical movement blocks 1 to 4 are included. At least one vertical movement block 124 may include a motor (such as a stepper motor) therein in order to cause movement of mixing bowl 130 in a vertical direction. In an alternative embodiment, a motor is mounted on the frame that supports vertical movement block 124. Such a motor may be attached to vertical movement block 124 with some sort of attachment means, such as a cable. When such a motor is actuated, the actuation of the motor causes vertical movement block 124 to be moved in a vertical direction. By actuating such a motor for a predetermined amount of time, vertical movement block can be moved vertically with a sufficient distance to cause mixing bowl 130 to be in the vicinity of a container 110 from which hair dye solution is to be dispensed.

FIG. 17 further illustrates optional features. These are features which may be included in alternative embodiments of the present invention. As shown, mixer 131 is included in mixing bowl 130. Thus, mixer 131 allows the contents of mixing bowl 130 to be mixed before the contents of mixing bowl 130 are retrieved by a stylist. After the various components of a hair dye mixture have been placed in mixing bowl 130, mixer 131 is then actuated to cause the contents of mixing bowl 130 to be mixed. As shown, and one exemplary embodiment, mixer 131 may include mixer vertical gear 132 and mixer horizontal gear 133. Thus, by actuating mix motor 134, mixer horizontal gear 133 begins to spin. This causes mixer vertical gear 132 to spin. This causes mixer 131 to spin, and thus the contents of mixing bowl 130 are mixed. As previously explained, in some embodiments, mixer 131 may not be used. Instead, the contents of mixing bowl are provided to a stylist who may then mix the hair dye solution mixture through other means, such as manual mixing.

In one exemplary embodiment, the contents of mixing bowl 130 are provided to the stylist by enabling a stylist to be able to retrieve mixing bowl 130. In other embodiments, it may be preferable to transfer the contents of mixing bowl 130 into another bowl. Then, that other bowl is retrieved by the stylist. In order to enable the contents of mixing bowl 130 to be transferred to another bowl, and exemplary mechanism is included via mix bowl pivot 140 which includes pivot horizontal gear 141 and pivot perpendicular gear 142. A motor (not shown) may be actuated to cause rotation of pivot perpendicular gear 142. This in turn will cause rotation of pivot horizontal gear 141. This in turn will cause mixing bowl 130 to rotate, thus causing the contents of mixing bowl 130 to be poured into another bowl. That other bowl is then retrieved by the stylist.

The entire mechanism that handles the transfer of mixed liquid from the bowl to the final container that the stylist will apply the color from is located on the cart that moves along the horizontal track. The mixing bowl is mounted into a thin flat circular plate which has a circular cutout for insertion of the mixing bowl. Attachment from the bowl to the plate will be made semi-permanent via shallow screws. On the outside of the plate closest to the sides of the machine are protruding cylinders to mount a gear on each side via set screws. Meshed with each of these gears will be a corresponding worm gear which will control the dumping motion of the mixing bowl. Controlling each worm gear will be a single small electric motor mounted to the cart with the shaft of the motor supported by a small structure with an imbedded ball bearing for friction reduction. The dumping mechanism works by the electric motor actuating which is connected to the worm gear and the motion of the worm gear switches the axis of rotation and allows the gear attached to the plate and ultimately the bowl to rotate toward the front dumping the mixture into a different container. When all the color is extracted with the rotation of the bowl toward the front of the machine, the motor would turn in the opposite direction which would cause the bowl to rotate back to its upright position.

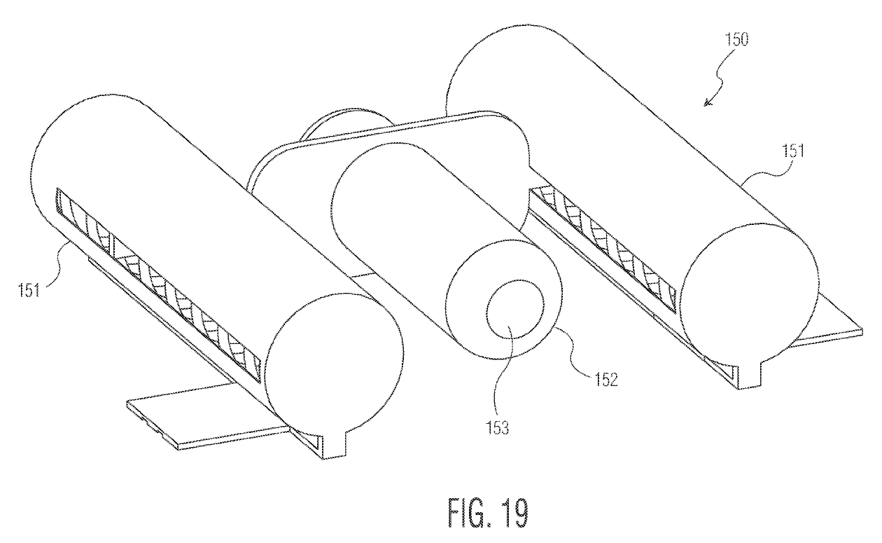

FIG. 18 is a further perspective view of mixing bowl 130. FIG. 18 further illustrates various embodiments of the present invention. Thus, mixer vertical gear 132, mixer horizontal gear 133 and mix motor 134 are shown for allowing the contents of mixing bowl 130 to be mixed. In addition, pivot horizontal gear 141, pivot perpendicular gear 142 and pivot motor 144 are shown for enabling the contents of mixing bowl 130 to be poured into another bowl.

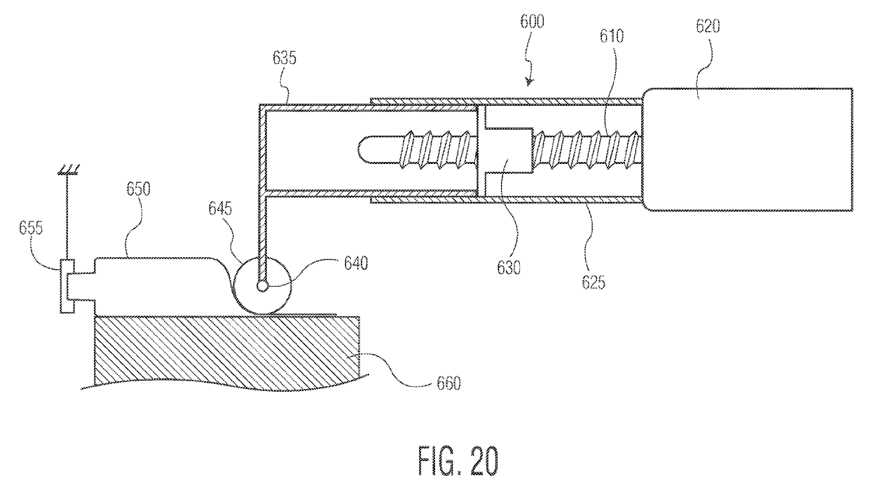

FIG. 19 illustrates an exemplary apparatus for causing the contents of any canister 110 to be dispensed into mixing bowl 130. In one exemplary embodiment, the exemplary apparatus shown in FIG. 19 is an actuator assembly 150 which, when positioned adjacent to any canister 110, applies pressure on the canister's valve, causing the valve to open and thus causing any hair dye solution stored in the canister under pressure to be dispensed into a mixing bowl. Actuator assembly 150 may be, for example one or more motorized linear actuators. FIG. 19 illustrates linear actuators 151 on both side of pressing mechanism 152 that when pressed against the nozzle of canister 110 causes the contents of canister 110 to be released under pressure. Pressing mechanism 152 includes opening 153 through which the contents of canister 110 are release. Thus, energizing the motorized linear actuators 151 (or the two on both sides of the pressing mechanism shown in FIG. 19) causes the pressing mechanism 152 to move toward the canister's valve, thus depressing the valve and permitting the contents of canister 110 to discharge through opening 153. In another exemplary embodiment, the apparatus shown in FIG. 19 provides pressurized gas (such as pressurized air). In this embodiment, a conduit is moved into position so that it engages gas inlet 117 (as shown in FIG. 12), and after engaging gas inlet 117, pressurized gas is released into canister 110 to cause hair dye solution to flow out of canister 110 and into mixing bowl 130.

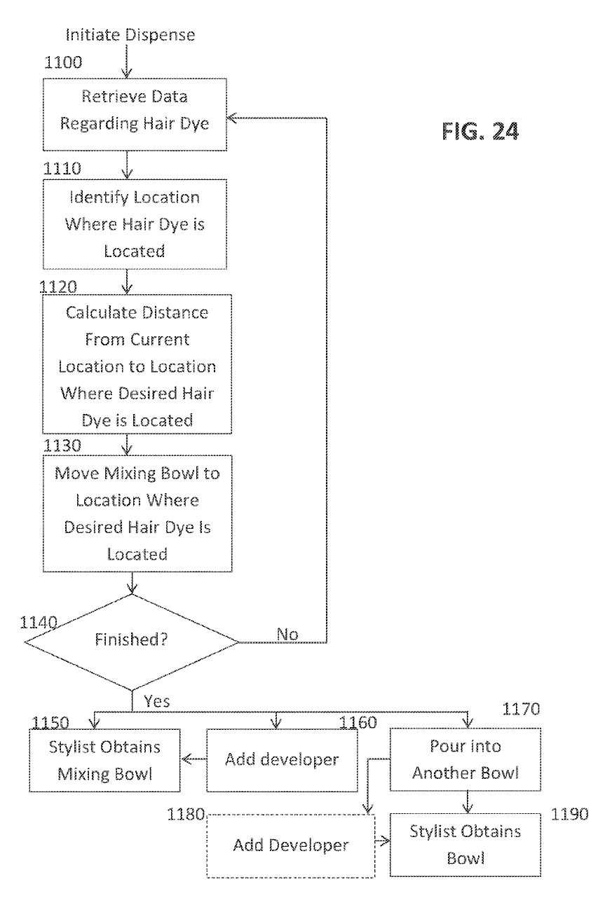

In a further exemplary embodiment, each canister 110 (or one or more canisters 110) includes some form of identification which may be used to determine whether canister 110 may be used as a source of hair dye solution. Thus, each canister is given some type of “tag.” The tag may take various forms including RFID, or an optical forms such as a barcode. Alternatively, the tag can be in a mechanical form, such that the mechanical shape needs to be a certain shape for canister 110 to be considered a permissible source of hair dye solution. In the embodiment shown, for example, in FIG. 14, each canister 110 is stored in a respectively different location. One or more of those locations may include an exemplary apparatus which can evaluate the tag on canister 110 stored therein and subsequently determine whether the tag indicates that dispensing of hair dye solution from canister 110 is permitted. Thus for example, at each location where a different canister 110 is included, there may be some type of sensor (e.g. an optical sensor) which evaluates a marking on canister 110 and determines whether the marking indicates that the use of the contents of canister 110 is permissible. This is further described below with reference to FIG. 23.

In addition to determining whether a tag (again, physical, optical, electrical, etc.) indicates that use of canister 110 is permissible, the tag may also be used to indicate the contents of canister 110. In this matter, if it is desired to obtain hair dye solution of a specific color/shade from canister, the tag enables identification of where such a canister may be located.

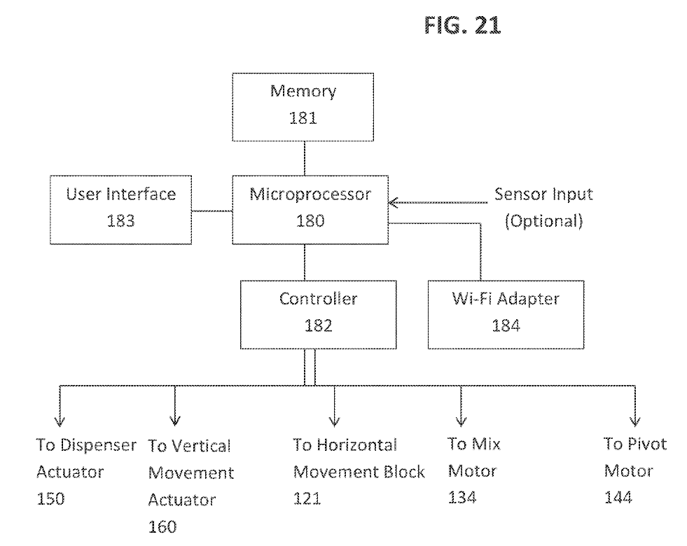

FIG. 20 illustrates a further exemplary embodiment for releasing hair color solution into a container such as mixing. In the exemplary embodiment shown in FIG. 20, canister 110 has been replaced with tube 650. While canister 110 may have a hard outer shell (although a soft shell may be used in some applications), tube 650 has a soft outer shell which can be deformed in order squeeze out its contents. Axle 640 supports roller 645. Axle 640 is coupled to the end of actuator 600. Thus, as actuator 600 extends, roller 645 moves across tube 650 and squeezes out the contents of tube 650. Tube 650 is illustrated as resting on stationary surface 660, although this is merely exemplary. In a further exemplary embodiment, two actuators 600 support two rollers 645 on opposite sides of tube 650, and squeeze tube 650 from opposite sides in order to cause the contents of tube 650 to be squeezed out.

Actuator 600 is comprised of motor 620 that rotates threaded shaft 610. Nut 630 is prevented from rotating within cylinder 625 (this is accomplished in various manners, including a ridge within piston 625 that engages a notch within nut 630. Thus, as motor 620 rotates, threaded shaft 610 rotates and nut 630 moves along shaft 610. Nut 630 is coupled to piston 635, thus causing piston 635 to move in and out within cylinder 625. Piston 635 is coupled to axle 640. Thus, energizing motor 620 causes roller 640 to move along tube 650, thus flattening tube 650 and causing its contents to be forced out of its open nozzle.

Optional valve 655 is located at the nozzle of tube 650. Optional valve 655 may be further opened or closed in order to provide further control of hair color dye being squeezed out of tube 650. Valve 655 may be supported by a stationary member in order to help keep tube 650 in place.

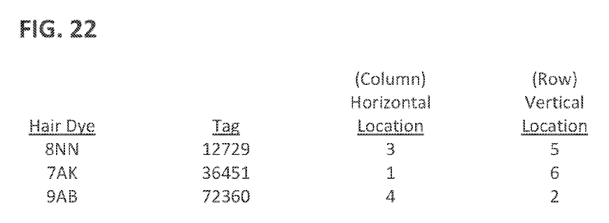

FIG. 21 is a block diagram of computer related electronics for controlling various aspects of color apparatus 105 in accordance with an exemplary embodiment of the present invention.

FIG. 21 illustrates various computer electronics for controlling various aspects of color apparatus 105. Microprocessor 180 is included. Microprocessor 180 is able to store and retrieve data from memory 181. User interface 183 is able to communicate with microprocessor 180. User interface 183 provides, for example, the user interface screens that are illustrated in FIG. 1 through FIG. 9. Optional sensors are able to track movement and/or identify location of various components associated with color apparatus 105. Wi-fi adapter 184 enables microprocessor 180 to communicate with a LAN (which in turn may be connected to the internet for communicating with e-commerce retailers, a central administrator, etc.) Controller 182 receives instructions from microprocessor 180. Controller 182 is able to control various aspects of color apparatus 105. Exemplary aspects of color apparatus 105 that are controlled by controller 182 are shown. These exemplary aspects include actuator assembly 150, vertical movement actuator 160, horizontal movement block 121, mix motor 134, pivot motor 144, etc. The operations performed by these various actuators, motors, etc. is as explained above. Controller 182 signals these various motors, actuators etc. in order to cause the various motion and or operation described above.

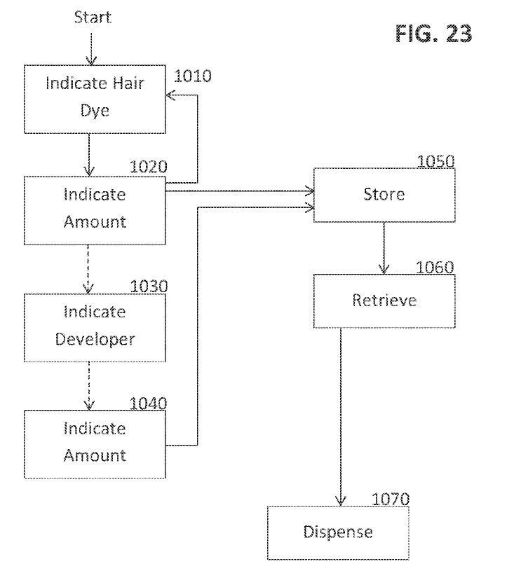

FIG. 22 is a table which illustrates how tags can be used to identify where a specific hair dye is located. FIG. 22 includes a hair dye column which indicates various shades of hair dye. Each shade of hair dye may be assigned its own respective tag number. Thus, in the example, hair dye shade 8NN is assigned tag number 12729. Once a stylist inserts a canister into the rack of canisters shown in FIG. 14, the tag number is read, a lookup table is consulted to determine the hair dye which corresponds to that tag number, and that hair dye is entered into the table shown in FIG. 22. Also, the location where the canister containing that hair dye is inserted into the rack is noted. As an example, assume that it has been predetermined that tag number 36451 corresponds to hair dye 7 AK. Also, assume that the stylist inserts that canister into the rack shown in FIG. 14, at the first column and the sixth row. Thus, as a canister that includes tag 36451 has been placed within the rack shown in FIG. 14, tag number 36451 is entered into the table, hair dye 7AK that corresponds to tag number 36451 is entered into the table, and horizontal location one and vertical location six is entered into the table. In this manner, if a stylist wishes to retrieve hair dye solution that is hair dye 7AK, mixing bowl 130 is moved along horizontal rails 120 and vertical rails 123 until mixing bowl is in the vicinity of canister 110 at column 1 and row 6.

The table shown in FIG. 22 may also be used, for example, to move mixing bowl 130 from the vicinity of one canister 110 to another canister 110. For example, again referring to FIG. 20, assume that a stylist wishes to include in his hair dye mixture hair dye 7AK and hair dye 9AB. Furthermore, assume that the stylist has informed the computer system that controls the movement of mixing bowl 130 that dispensing of hair dye 7AK and hair dye 9AB is desired. Assume also that mixing bowl 130 has been moved into the vicinity of column 1 and row six so that hair dye 7 AK may be dispensed. After hair dye 7AK has been dispensed, mixing bowl 130 is then to be moved into position so that hair dye 9AB can be dispensed. FIG. 22 indicates that the canister 110 that includes hair dye 9AB is located at column 4 and row 2. Thus, in order to move the mixing bowl from column 1 to column 4, the stepper motors responsible for horizontal motion of mixing bowl 130 are actuated a sufficient amount of time to move mixing bowl 130 three columns to the right. Furthermore, the motors responsible for vertical motion of mixing bowl 130 are instructed to move mixing bowl 130 from Row 6 to Row 2. Thus, those actuators are instructed to move mixing bowl 130 four rows upwards. In this manner, mixing bowl 130 is moved from hair dye 7AK to hair dye 9AB. Hair dye 9AB can then be dispensed.

The table shown in FIG. 22 may also be used to keep track of how much content has been dispensed from each canister. Regardless of where this information is stored, this information can be used for a variety of functions. The information can be used for provide reports regarding how much of each hair dye solution has been used, how much has been used during a time period, how much has been used by a particular stylist, and how much has been used for a particular customer. The information can also be used to alert a person (such as a salon owner), that certain hair dye solutions need to be reordered. The information can also be used in an automated system, to automatically reorder the hair dye solution (e.g. over the internet) and to have the hair dye solution automatically shipped to the salon that desires more of a particular hair dye solution to remain appropriately stocked.

In a further exemplary embodiment of the present invention, reordering of hair dye solution is automated, based at least in part on scheduling of customers within a salon. Thus, for example, a salon may have scheduling software that includes information (i.e. appointment dates) regarding future appointments of customers for the purpose of hair coloring. In one exemplary embodiment of the present invention, the information regarding customers that will be coming into the salon is evaluated in combination with known existing stock of hair dye solution (and also, possibly, hair dye solution that has been ordered and is expected to arrive at the salon at a time in the future). In particular, if the combination (and quantity) of hair dye solutions that will be needed for customers is known (i.e. previously stored in a database as described above), it is then possible to determine whether the salon has sufficient stock of hair dye solution for those customers. Furthermore, if it is determined that the stock of hair dye solution in the salon is insufficient for the customers that are expected in the future, a distributor can be signaled to provide (i.e. ship) hair dye solution to the salon, so that the salon has sufficient stock when customers arrive for their appointments in the future.

In the above exemplary embodiment, the location of canisters 110 can be dynamic.

In other words, by simply inserting a canister into location, the contents of the canister are identified, when a stylist desires the dispensing of hair dye solution in a desired shade, mixing bowl 130 can be moved into position for dispensing of that shade based on the identification information included in the canister's tag. In an alternative embodiment of the present invention, the location of various canisters 110 may be fixed. Thus, it may be required that canisters be inserted into various locations based on predefined information. For example, the location of canisters that contain specific hair dyes may need to be entered manually, and then canisters placed in those locations based on the previous manual entering of that information.

FIG. 23 is a flowchart diagram which illustrates indicating hair dyes and amounts in accordance with an exemplary embodiment of the present invention. Thus, for example, the steps illustrated in FIG. 23 may be used in combination with the graphic user interface previously disclosed. At step 1010, a hair dye is indicated. At step 1020, and amounts of the previously indicated hair dye is indicated, (reversible order Operation then returns to 1010 until all desired hair dyes and amounts have been entered. At step 1050, the information entered at steps 1010 and 1020 is stored. An optional step 1030 allows developer to be indicated. An optional step 1040 allows the amount of developer to be indicated. If developer and its amount or indicated, than this information is also stored at step 1050. At step 1060 the stored information is retrieved. This may be accomplished using any of the exemplary methods which are described above. Finally, at step 1070, the hair dye mixture is dispensed.

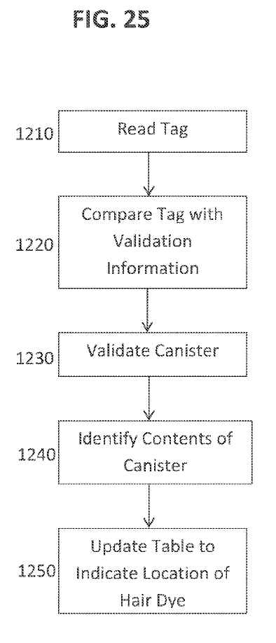

FIG. 24 is a flowchart diagram which illustrates dispensing of a mixture of hair dye solution in accordance with an exemplary embodiment of the present invention. At step 1100, data regarding a hair dye is retrieved. At step 1110, the location where a canister which stores the hair dye is identified. At step 1120, the distances calculated between the current location of a bowl that will be used to contain the hair dye mixture and the desired location where the bowl needs to be moved to in order to receive the next hair dye solution that will be dispensed. At step 1130, the bowl that will hold the mixture of hair dye solution is moved to the location where the next hair dye solution will be dispensed. At step 1140, a determination is made as to whether all hair dye solutions have been dispensed into the mixing bowl. If all hair dye solutions have not been dispensed into the mixing bowl, then processing continues to step 1100. Otherwise, if all hair dye solutions have been dispensed into the bowl, processing proceeds to steps 1150, 1160, or 1170. At step 1150, the stylist is able to obtain the mixing bowl. Alternatively, at step 1160, developer is added into the mixing bowl and then processing proceeds at step 1150 where the stylist has access to the mixing bowl. At step 1170, the contents of the mixing bowl are poured into another bowl. At step 1180, the optional step of adding developer occurs. At step 1190, the stylist obtained access to the bowl (with or without the developer). In various exemplary embodiments, mixing of the contents of the mixing bowl may occur before the stylist is able to obtain access to its contents or after the stylist obtains access to the contents of the mixing bowl.

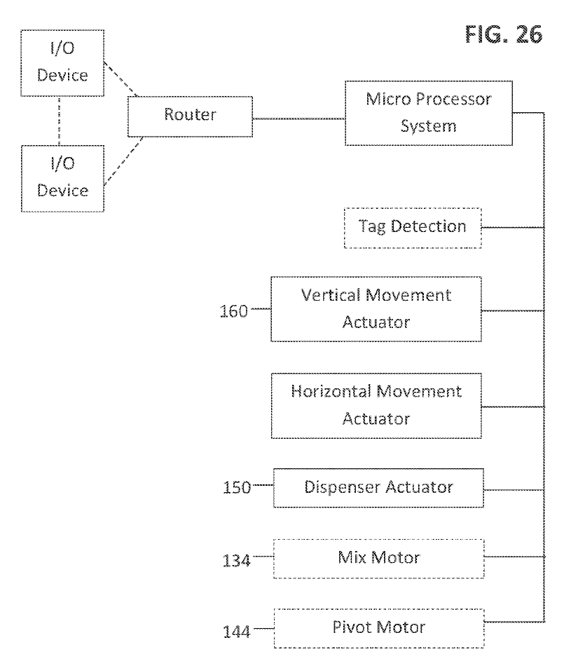

FIG. 25 is a flowchart diagram that illustrates the use of validation tags that may also be used to identify location of canisters within color apparatus 105. At step 1210 a tag located on a newly received canister 110 is read. Exemplary tags include barcode, Q-code, RFID, etc. Reading of the tag may take place after canister 110 has been placed at a location within rack 191. Thus, when a newly received canister 110 is inserted in rack 191, the contents of newly received canister 110 may not immediately be known to color apparatus 105. Color apparatus 105 may need this information in order to know from which column and row to retrieve a requested color dye solution. At step 1220, the information obtained with the read tag is compared with validation information stored within color apparatus 105. The validation information may be obtained, for example over the internet using Wi-Fi adapter 184. In this manner, for example, it is possible to determine whether canister 110 (or some other container from which color dye solution is dispensed) has been purchased from an authorized source. At step 1230, canister 110 is validated (i.e. does the validation information correspond with information obtained from the tag on canister 110?). At step 1240, the information on canister 110's tag is used to identify the contents of canister 110 (i.e. what shade of hair color solution is stored within canister 110?). At step 1250, the table within color apparatus 105 is updated to reflect the shade of hair dye solution that is stored at the location where newly received canister 110 has been placed within rack 191. Therefore, when the contents of newly received canister 110 are requested to be part of a mixture of color dye solutions, color apparatus 105 knows the location within rack 191 from which each color dye solution is to be obtained.

In an alternative embodiment, a scanner scans each canister 110 before insertion into rack 110. The location of the scanned canister 110 may then be entered manually, for example (such as on a keyboard—a dedicated keyboard, a keyboard on a smartphone or tablet, etc.)

In an alternative embodiment, information on the outside of canister 110 is manually entered, and the location of canister 110 within rack 191 is manually entered. Validation may thus occur based on the manually entered information.

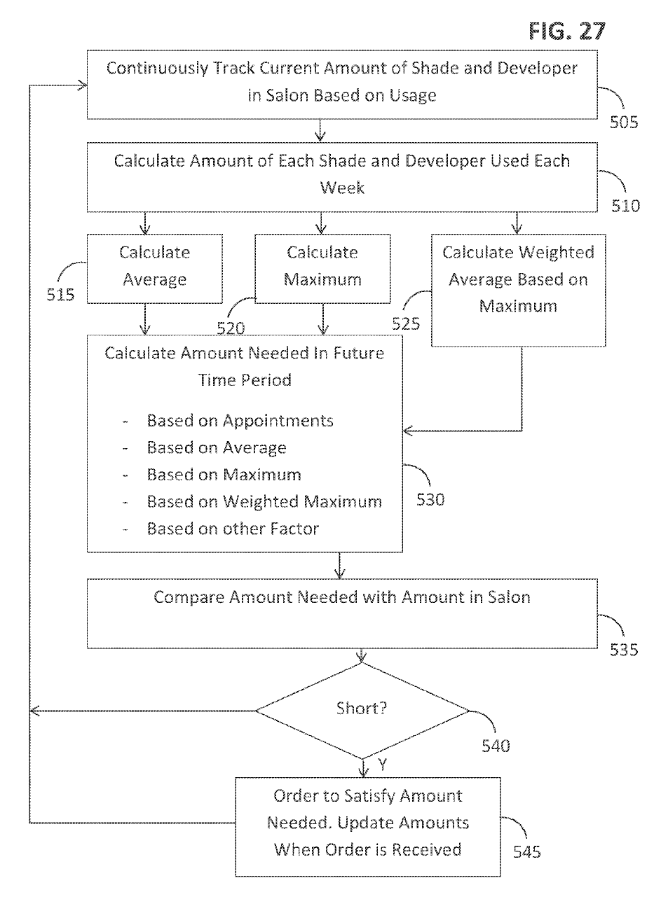

FIG. 26 is a block diagram that illustrates various hardware components and communication therebetween, including a microprocessor system, a router, I/O devices, vertical movement actuator 160, horizontal movement actuator, dispenser actuator 150, optional mix motor 134, optional pivot motor 144 and optional tag detection (for scanning each canister 110, for example).

As color apparatus 105 is operating in a salon, all the color formulations created using color apparatus 105 may be tracked and turned into empirical data which can be used to analyze the usage of the various shades of hair color and developer. Since all of the clients of a particular salon will be entered into the “client book” section of the user interface, all the data regarding their color usage history may be available including, but not limited to, the color shades and quantities of color shades, type and amount of developer, dates and frequency of visitation to the salon. Color apparatus 105 desirably analyzes all of the data from all of the clients entered into color apparatus 105. Also, historical data from busier times of the year, seasons, weather, geographic location, holidays, among others can be taken in account during the process of automatically reordering color shade solution. From this data, predictions can be made for the future usage of color shades and developers. This predictive system can also be coupled with scheduling software. Color apparatus 105 may be able to recognize names and dates from the client appointments and since the usage data for these clients is already in color apparatus 105, usage predictions can be calculated. When color apparatus 105 recognizes that the available salon inventory of certain color shades and developers is depleted or will be depleted in the future to a certain point of resupply, the distributor is notified of the color shades and developers and the quantities needed. Payment for the resupply may be made possible through color apparatus 105 as well. These quantities will be calculated based on the predicted usage data. During every resupply period for each color shade, analysis is done by color apparatus 105 on the accuracy of the usage predictions against the actual usage. The data generated by these analyses will allow for more accurate future usage predictions for the lifetime of the system.

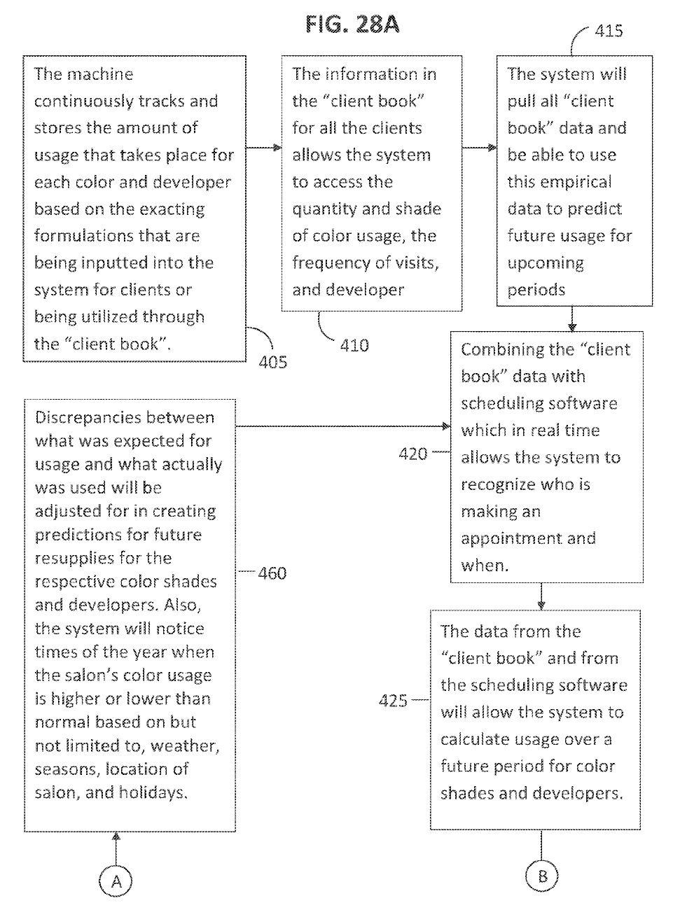

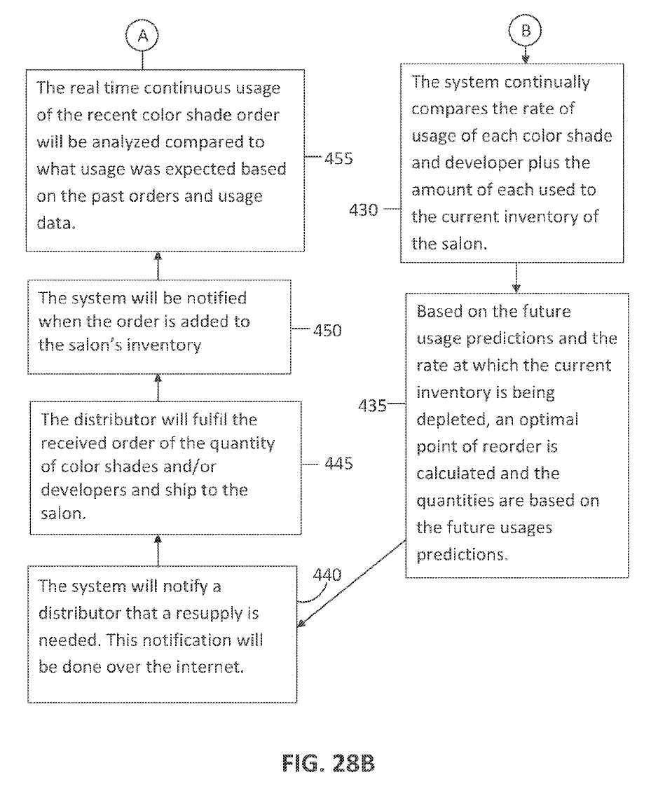

FIGS. 27, 28A and 28B are flow chart diagrams that illustrate exemplary steps for providing sufficient amounts of color solution in accordance with an exemplary embodiment of the present invention.

The flowchart diagram illustrated in FIGS. 27, 28A and 28B provide useful technical features and advantages. It is known to one of ordinary skill in the art that hair salons struggle with maintaining sufficient amounts of color shade solution available for their clients. As previously described and illustrated in the figures, hair salons normally stock a large selection of different hair color solution. This is desirable because clients desire a hair dye solution mixture that is obtained from a very large range of hair dye solutions that are available on the market. Thus, hair salons stock a large variety of different hair dye solutions because they need to have these various heart hair dye solutions available to their customers.

To put it another way, a salon very much wants to avoid the situation where a customer walks in, wants their hair to be died a certain shade, and the salon is unable to accommodate customer because one of the hair dye solutions that is needed to create the desired color is not in stock with in the hair salon. This may be the result, for example, of having “run out” of a certain hair dye solution prior to a customer entering the hair salon. If a certain shade of hair dye solution is unavailable to the salon, and the salon cannot give the customer the hair color that the customer desires, it is very possible for the hair salon to lose the sale.

The use of the various motors and actuators described above provides a technical solution to this problem. This technical solution provide significant advantages over the prior art by trying to provide sufficient quantities of various color shade solutions (i.e. color shade solutions in various colors). As previously described, a user interface allows various color shade solutions to be selected, and the various motors and actuators described above cause the requested color dye solutions to be automatically dispensed. The combination of these features in conjunction with various rules and algorithms can help a salon to try to stock appropriate inventory.

One of the aspects of this exemplary embodiment of the present invention is that many customers are repeat customers. Also, repeat customers may come to a salon for hair color treatment at regular time intervals. In an exemplary embodiment of the present invention, this information is used in combination with the various quantities of hair dye solution that are dispensed in order to ensure adequate stock of hair dye solution.

FIG. 27 is thus a flow chart diagram that illustrates exemplary steps for providing sufficient amounts of color solution in accordance with a further exemplary embodiment of the present invention.

At step 505, color apparatus 105 continuously tracks current amount of shade and developer in the salon based on usage.

At step 510, color apparatus 105 calculates amount of each shade and developer that are used each week.

In various exemplary embodiments of the present invention, various dates are used to determine how much color shade solution and/or developer should be reordered. For example, at step 515, color shade solution is reordered based on average amounts of each color shade solution used in previous weeks. Alternatively, or in addition, amounts of color shade solution to be reordered are calculated based on maximum amounts of color shade solution used in various time periods (such as weekly, monthly, etc.). Alternatively, step 525 reordering of color shade solution and/or developer is calculated using a weighted average, a maximum amount of previous time period, etc.

At step 530, color apparatus 105 calculates amount of each color shade solution (and/or developer) needed (or expected to be used) in one or more future time periods. This calculation may be based on the amounts of color dye solutions that customer have used in previous appointments, average amounts of color dye solution used over one or more time intervals, maximum amounts of color dye solutions used over one or more time intervals, weighted maximums, other factors as previously described such as time of year, holidays, etc.

At step 535, color apparatus 105 performs a comparison between the amount of color dye solution calculated at step 530 and the amount of color dye solution actually in stock in the salon. This step is performed in order to determine if sufficient amounts of color shade solution are stored (based, for example, on what has been previously stored, use that has been tracked, and the previous calculation.

At step 540, processing proceeds to either step 505 or step 545 based on the results of the comparison in step 535.

At step 545, color dye solution is ordered to satisfy the amount needed. In this manner, physical amounts of color shade solution are acquired. Once received by the salon, the amount received is updated within color apparatus 105. Processing then proceeds to step 505.

Returning to FIGS. 28A and 28B, at step 405, color apparatus 105 continuously tracks and stores the amount of color shade solution that is being used. This tracking may be based on actual amounts of color shade solutions dispensed. This tracking may also be based on the combination quantities of color shade solution that are stored for each client within memory 181. As previously explained, and is illustrated with respect to FIG. 7, each customer has maintained a respective record of the color dye solution combination that each customer normally receives. This information may also be used in order to calculate and obtain color dye solution for future use. In a further exemplary embodiment of the present invention, color dye solution is acquired for further use based upon a combination of previous actual usage and data stored for each customer in conjunction with the user interface illustrated in FIG. 7.

At step 410, information for all clients allows color apparatus 105 to access type and quantity of color shade solution, the frequency of visits by each customer, and the amount of developer used.

At step 415, available data is used to predict future usage of various color shade solutions.

At step 420, the client book data in combination with scheduling software enables color apparatus 105 to recognize who is making an appointment and when.

At step 425, data stored for each client is evaluated in combination with client schedules to calculate usage of color shade solutions over future time periods for various color shade solutions and for various developers.

At step 430, color apparatus 105 continuously compares the rate of usage of each color shade solution and developer with the amount of each used to the current inventory of the salon.

At step 435, based on future usage predictions and the rate at which the current inventory is being depleted, an optimal point of reorder is calculated and the quantities are based on the future usage predictions.

At step 440, color apparatus 105 automatically notifies a distributor through electronic means that a resupply is needed. In one exemplary embodiment, this communication can occur over the Internet.

At step 445, a distributor receives the order for various quantities of color shade solutions and/or developers and ships these products to the hair salon.

At step 450, color apparatus 105 is notified when shipped color shade solution and/or developer has been received. This information is updated in color apparatus 105 for that color apparatus 105 again has an accurate indication of the amounts of color shade solution and/or developer that are actually available and in stock within the hair salon. At step 455, usage of color shade solutions and/or developer that are in stock are further analyzed and compared with previous usage based on past orders and usage data.

At step 460, discrepancies between what was expected for usage in what actually was used will be adjusted for creating better predictions for future resupply's of respective color shade solutions and developers. In a further exemplary embodiment of the present invention, color apparatus 105 may include weightings that are used to adjust amounts of color shade solutions that are ordered in view of historical trends such as, for example, time of the year, weather, seasons, salon location, holidays, etc.

An example may be illustrative. In previous weeks use of color shade solution 7NN has been at the following quantities:

TABLE I

| | |
|---|---|
| Week 1 | 160 ml |
| Week 2 | 200 ml |
| Week 3 | 170 ml |
| Week 4 | 190 ml |

It is calculated that on average 180 ml of 7NN are used per week. At the beginning of Week 5, a salon has 210 ml of 7NN in stock. In one exemplary embodiment, the calculation is performed to make sure in Week 6, the average is available, plus an error factor (assume 50 ml). Therefore the algorithm wants to have the average plus 50 ml available in Week 6. The algorithm subtracts 180 ml (the average) from 210 ml (current amount in stock) and estimates 30 ml will be left by the end of the week. The algorithm wants for Week 6 there to be the average (180 ml) plus the error factor (50 ml) for a total of 230 ml. Since 30 ml is estimated to be left at the end of Week 5, the algorithm computes that 200 ml will be needed to achieve the 230 ml total that is desired. The algorithm therefore automatically orders enough containers of 7NN so that the 230 ml total can be obtained. The order is placed over the Internet (for example) and when the 7NN arrives at the salon, the actual amount that has arrived is entered. The algorithm can then perform calculations for subsequent weeks, and order appropriate amounts, based on the actual amount of 7NN that has arrived at the salon.

The above description is merely an example. In an alternative embodiment, the algorithm evaluates the database records of each person who is scheduled to have their hair dyed in Week 6. For example, the algorithm can evaluate how much 7NN will be used by all of the people having their hair dyed in Week 6 (based on their history that has been previously stored). Assume for example that the algorithm computes that the customers scheduled for Week 6 on average use 300 ml of 7NN. Although the average computed above was 180 ml, the algorithm has determined that 180 ml will not be enough (based on the people that actually have appointments), and will increase the order for delivery of more 7NN so that more than 300 ml of 7NN is present in the salon at the beginning of Week 6.

Or assume that Week 6 is the week before Christmas when business is much greater than other times of the year. The algorithm can apply a multiplier (assume 1.5×) to that week and determine that 270 ml (180 ml average×1.5 multiplier) plus any error factor needs to be present in the salon. The 7NN reorder can thus be based on the average and multiplier (rather than just the average).

These are merely examples of how the algorithm can determine how much hair color solution to reorder. Part of the reason why this algorithm is so useful is because of the automated manner in which hair color solution is dispensed by color apparatus 105. Each time hair color solution is dispensed, the amount that has been dispensed is saved so that the exemplary calculations described above can be performed. For example, it is possible to determine how much hair color solution has been dispensed based on the amount of time hair color solution is permitted to exit from canister 110 (or the amount of actuation of actuator 600 in FIG. 20). The combination of automated dispensing and automated product reordering provides significant advantages that cannot be achieved by either aspect of exemplary embodiments of the invention. As a result, for example, salons have sufficient hair color solution for all customers that will require hair color solution each week. By purchasing hair color solution in this manner, salons are able to optimize the amount of money they are using for supplies. Salons are also better able to have on stock what they need to accommodate all customers that use the salon that week (and not lose a sale due to insufficient amounts of hair color solution). The salon is not exceeding storage space with hair color solution that will not be needed in a particular week. Human error is decreased. Individuals do not need to spend time monitoring hair color solution use and reordering solution. The salon is better able to track hair color solution use to prevent waste or theft. Anomalies in the typical rate at which hair color solution is used can be accommodated for to provide additional hair color solution during “surge” week and less hair color solution during typical “slow” weeks. In a further embodiment, if the amount of hair color solution at the end of the week is too low (i.e. below a threshold), a multiplier may be applied to the reorder amount in order to increase the “cushion” within the salon so that running out of a particular hair color solution is hopefully prevented.

A further example may be illustrative. “Nancy” visits the salon and gets 100 mL of 7NN mixed with 100 mL of 20 vol developer. Since this information is saved it can be referenced. If Nancy returns to the salon, for example, in three weeks and gets the same formula, a frequency of visitation can be extrapolated. Thus, for Nancy, every three weeks (or any other span of time) her usage is 100 mL of both 7NN and 20 vol. Combining Nancy's typical usage over a certain future period with other clients who also use 7NN and 20 vol will give a total usage prediction over that period of time.

If the reorder period was deemed to be a one week span (other increments are also possible), then the week that Nancy comes in there is desirably at least 100 mL of 7NN and 20 vol developer along with a determined reserve amount. In this case, 50 mL of 7NN. These usages will be additive for all clients. The typical cyclic nature of the clients' visits will be determined based on the frequency extrapolation. Additionally, a scheduling software link will create more accuracy in determining when Nancy will be coming in for color again.

In normal day to day operation there will be the predicted usages calculated and the reorder date/time will be known due to the usage predictions against the current inventory.

For example, there will be 750 mL of 7NN used over the next four days on scheduled clients, and there is 800 mL of 7NN in inventory, then there needs to be a resupply of a determined amount of color based on future scheduled clients before that fourth day. Also, the reorder day can be set, for example on a Friday every week, and the usage for that period can be determined and resupplied based on actual usage.

Additionally, whenever a client gets hair color solution, color apparatus is recalculating the inventory, usage of that color/developer, and possible reorder date/amount against what was predicted. For example, if Nancy comes in a day early for her typical three week cycle, then 100 mL of 7NN will be subtracted from the inventory, added to the usage, and the reorder date will be moved up to accommodate for the change while allowing adequate supply of 7NN for the clients in the near future based on the predictions.

When color apparatus 105 automatically notifies the distributor and receives a resupply, in this case 1000 mL, the system will be notified that it has arrived and will be added to the available inventory. The new added inventory real time usage will again be analyzed compared to the expected usage patterns. Any discrepancies between what usage was expected and what was experienced due to possible unscheduled clients, new clients, weather, seasons, salon location, holidays, among others will be noted. These discrepancies will allow calculations to be made for accounting and correcting for them for future ordering cycles. For example method of calculating, if there are on average three unscheduled clients every two weeks using an average of 50 mL of 7NN. Then an amount greater than 150 mL of 7NN will be added to the future orders to accompany the potential maximum amount of unscheduled clients and volumes that are being used on them. If a jump in usage appears during a holiday period, then for an example calculation, a multiplier may be used to determine future usage. This multiplier may be based on past holiday period usage experience. If usage increased 50% compared to the normal usage for the time period then if the usage for the time period would have been 500 mL then the prediction would increase to 750 mL.

Over time, if there is a pervasive over or under prediction of color usage, due to any number of reasons, certain mathematical calculations will be applied to correct for these inaccuracies. For example, if there is a surplus of 100 mL over what was originally the reorder period, then the system will recognize that there needs to be a mathematical adjustment and may employ a function such as the following to reduce the surplus. The pervading surplus may be diminished by 20% every reorder cycle where it is deemed to be above the acceptable amount of surplus. So in this case, in the reorder cycle following the 100 mL surplus cycle, the order may be reduced by 20 mL. Then in the following cycle the surplus was determined to be 60 mL. The following order may be reduced by 12 mL. This will continue until an acceptable amount (percent or otherwise) of the order is a surplus or deficit and there is minimal amount of surplus or deficit variation cycle to cycle.

As previously explained, reordering of color dye solution may take place over the internet. For internet connectivity, Wi-Fi adapter 184 of FIG. 21 may be used. In one exemplary embodiment of the represent invention, the various elements of FIG. 21 may be (at least partially) implemented with a microprocessor system such as a Raspberry Pi 3 Model B (which has Wi-Fi, Bluetooth and wired Ethernet capability). The Raspberry Pi can be configured to the Wi-Fi network of the salon to allow for wireless communications between color apparatus 105 and the various e-commerce providers.

One exemplary function that may use this internet connectivity is the communication of orders of the various color shades and developers, to various distributors. Another exemplary function may include interconnectivity of all the usage data from a plurality of color apparatus 105 to a system administrator. The usage data may be communicated over the internet to create data on usage based on common geographic locations, weather, times of the year, etc. A third exemplary function is to communicate to a central administrator maintenance status or usability of the machine and the system components. A fourth exemplary function is for the authorization of a canister (i.e. a canister of hair color solution can be sold to a sold and then “activated” after it is installed in color apparatus 105. The authorizing code or protocol are desirably changed on color apparatus 105 remotely. Allowing the authorization process to be dynamic prevents imposter canisters from being used. A fifth exemplary function is app connectivity between the system and an outside device which has the specified app installed on it. Additionally, the outside personal device can be connected to the system via Bluetooth instead of a Wi-Fi connection. The Bluetooth connection is also supported by the Raspberry Pi 3 Model B and other devices like it.

One aspect of the present invention relates to chemicals for changing the color of hair. In this regard, several phrases may be used to describe these chemicals. Exemplary phrases include, but are not limited to: hair color, hair coloring, hair dye, color solution, hair color solution, dye solution, hair dye solution, shade solution, color shade solution, etc. Furthermore, while the explanation above has been with regard to mixing chemicals for changing the color of hair, it is understood that the present invention may be applicable to other chemical mixing as well,

While the present invention has been described herein with reference to exemplary embodiments, it should be understood that the invention is not limited thereto. Those skilled in the art with an access to the teachings herein will recognize additional modifications, applications, and embodiments within the scope thereof and additional fields in which the invention would be useful.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.).

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein, it is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

### PARTS LIST

100 Login Screen
200 Main Menu Page
201 Mixing Bowl Option
202 Reports Option
203 Client Book Option
204 Settings Option
300 Mixing Page
301 Virtual Cylinder
302 Level Selection
303 Developer Section
304 Dispense Button
305 Unit Selection
306 Sublevel Selection
307 Post Dispense Menu
700 Saved Clients Menu
701 Search Box
702 Sort Options
703 Client Selection
704 View Selector
800 Client Page
801 Client Data
802 Hair Color Formula
803 Share Feature
804 Client Action Selector
805 Last Visit Data
806 Notes
900 Reports Page
901 Range Selector
902 Client Number
903 Dollar Tracker
904 Quantity Tracker
105 Color Apparatus
110 Canister
111 Body
112 Cavity
113 Dispenser
114 Dispensing Control
115 Dispenser Outlet
(not shown) Valve
116 Smart Chip
120 Horizontal Rails
121 Horizontal Movement Block
122 Base
123 Vertical Rails
124 Vertical Movement Block
130 Mixing Bowl
131 Mixer
132 Mixer Vertical Gear
133 Mixer Horizontal Gear
134 Mix Motor
140 Mix Bowl Pivot
141 Pivot Horizontal Gear
142 Pivot Perpendicular Gear
143 Pivot
144 Pivot Motor
150 Actuator Assembly
160 Vertical Movement Actuator
180 Microprocessor
181 Memory
182 Controller
183 User Interface
184 Wi-Fi Adapter
191 Rack
600 Actuator
610 Shaft
620 Motor
625 Cylinder
630 Nut
635 Piston
640 Roller
650 Tube
655 Valve

1) A method of creating color solution, said method comprising the steps of:
a) receiving color shade solution values corresponding to respectively different color shade solutions and color shade quantity values corresponding to respectively different amounts of said respective color shade solutions;
b) mapping each of said received color shade solution values to respectively different physical locations where said respective color shade solutions are stored in respectively different containers;
c) signaling at least one actuator under microprocessor control to release into a mixing container more than one of said respective color shade solutions in said respective amounts from said respectively different containers based on said received color shade solution values and said received color shade quantity values, and step b); and
d) energizing at least one further actuator or motor that moves at least one of
a. said container containing said respectively different color shade solutions; and
b. said mixing container
towards each other based on said mapping in order to combine ones of said respectively different color shade solutions that correspond to ones of said color shade solution values received in step a).

2) A method according to claim 1, further comprising the steps of:
e) storing in non-transient memory amounts of said color shade solution physically used after said respective color shade solutions are released in step c);
f) tracking amounts of color shade solutions physically stored;
g) calculating amounts of color shade solution expected to be used in one or more future time periods based on step e);
h) determining if sufficient color shade solutions are stored based on steps e), g) and h);
i) acquiring physical amounts of color shade solutions after calculating said physical amounts from steps e), f), g) and h).

3) A method according to claim 2, wherein step i) is performed by electronically purchasing said color shade solutions in said physical amounts.

4) A method of creating color solution according to claim 1, wherein step c) includes the step of moving said mixing container towards each of said respective color shade solutions and then dispensing said respective color shade solutions into said mixing bowl.

5) A method of creating color solution according to claim 1, wherein step c) includes the step of moving said respective color shade solutions towards said mixing bowl and then dispensing said respective color shade solutions into said mixing bowl.

6) A method of creating color solution according to claim 1, said method further comprising the step of:
e) mixing said respective color shade solutions in said mixing bowl.

7) A method of creating color solution according to claim 1, wherein at least one of steps a), b) and c) are performed under microprocessor control.

8) A method of creating color solution according to claim 1, wherein step c) said respective color shade solutions are released from said respective containers into said mixing container.

9) A method of creating color solution according to claim 3, step c) further includes the step of providing force in order to move said mixing container at least one of vertically and horizontally in order to move said mixing container towards said respective color shade solutions.

10) A method of creating color solution according to claim 1, wherein each of said containers includes identification information that identifies whether release of color shade solutions from said containers is permitted.

11) A method of creating color solution according to claim 1, wherein each of said containers includes identification information that identifies contents of said containers, location of each of said containers is recorded based on said identification information, and said color shade solutions are released into said mixing container based on location recorded for each of said containers.

12) (canceled)

13) Apparatus for creating color solution, said apparatus comprising:
a) a memory unit from which is obtained color shade solution values corresponding to respectively different color shade solutions and color shade quantity values corresponding to respectively different amounts of said respective color shade solutions;
b) a mapping unit for mapping each of said received color shade solution values to respectively different physical locations where said respective color shade solutions are stored in respectively different containers;
c) an actuator for releasing into a mixing container more than one of said respective color shade solutions in said respective amounts from said respectively different containers based on said receive color shade solution values and said received color shade quantity values and said mapping; and
d) at least one further actuator or motor that when energized moves at least one of:
a. said different containers containing said respectively different color shade solutions; and
b. said mixing container
towards each other based on said mapping in order to combine ones of said respectively different color shade solutions that correspond to ones of said color shade solution values obtained from said memory.

14) Apparatus according to claim 13, further comprising a processor for:
storing in non-transient memory amounts of said color shade solution physically used after said respective color shade solutions are released in step c); tracking amounts of color shade solutions physically stored;
calculating amounts of color shade solution expected to be used in one or more future time periods based on said storing;
determining if sufficient color shade solutions are stored based on said storing, said tracking and said calculating;
acquiring physical amounts of color shade solutions after calculating said physical amounts from said determining

15) (canceled)

16) Apparatus according to claim 13, wherein said motors or actuators move said mixing container towards each of said respective color shade solutions and then dispense said respective color shade solutions into said mixing bowl.

17) Apparatus according to claim 13, wherein said motors or actuators move said respective color shade solutions towards said mixing bowl and then dispensing said respective color shade solutions into said mixing bowl.

18) (canceled)

19) Apparatus according to claim 13 wherein force is provided in order to move said mixing container at least one of vertically and horizontally in order to move said mixing container towards said respective color shade solutions.

20) Apparatus according to claim 13, wherein each of said containers includes identification information that identifies whether release of color shade solutions from said containers is permitted.

21) Apparatus according to claim 13, wherein each of said containers includes identification information that identifies contents of said containers, location of each of said containers is recorded based on said identification information, and said color shade solutions are released into said mixing container based on location recorded for each of said containers.

22)-30) (canceled)

31) A method according to claim 2, wherein said calculating is adjusted to increase or decrease amount of said color shade solution based on amounts of said color shade solution used or stored in previous time periods.

32) (canceled)

33) (canceled)

34) A non-transitory computer readable storage medium comprising computer executable instructions for creating color solution, comprising instructions for:
a) receiving color shade solution values corresponding to respectively different color shade solutions and color shade quantity values corresponding to respectively different amounts of said respective color shade solutions;
b) mapping each of said received color shade solution values to respectively different physical locations where said respective color shade solutions are stored in respectively different containers;
c) signaling at least one actuator under microprocessor control to release into a mixing container more than one of said respective color shade solutions in said respective amounts from said respectively different containers based on said received color shade solution values and said received color shade quantity values, and step b); and
d) energizing at least one further actuator or motor that moves at least one of
a. said container containing said respectively different color shade solutions; and
b. said mixing container
towards each other based on said mapping in order to combine ones of said respectively different color shade solutions that correspond to ones of said color shade solution values received in step a).
